(19) United States
(12) Patent Application Publication
(10) Pub. No.: US 2026/0244654 A1
(43) Pub. Date: Aug. 20, 2026

(54) HYPOTHESIS GENERATION DEVICE AND HYPOTHESIS GENERATION METHOD

(71) Applicant: National Institute of Information and Communications Technology, Tokyo (JP)

(72) Inventors: Ryu IIDA, Tokyo (JP); Kentaro TORISAWA, Tokyo (JP)

(73) Assignee: National Institute of Information and Communications Technology, Tokyo (JP)

(21) Appl. No.: 19/161,077

(22) PCT Filed: Feb. 15, 2024
(86) PCT No.: PCT/JP2024/005157

§ 371 Date: Aug. 29, 2025

(30) Foreign Application Priority Data
Mar. 27, 2023 (JP) 2023-049274

(51) Int. Cl. G06F 16/3329

(52) U.S. Cl. CPC G06F 16/33295

(57) ABSTRACT

Provided are hypothesis generation device and hypothesis generation method that can generate interesting hypotheses of high reliability that are related to the input contents but require deeper insight. The hypothesis generation device 100 includes: a related text forming unit 114, responsive to an input text 110 for generating a related text related to the input text 110; and a hypothesis generating neural network 122 responsive to input of the text and the related text, trained in advance to generate a hypothesis from input text 110.

### TECHNICAL FIELD

The present invention relates to a hypothesis generation technique and, more specifically, to a hypothesis generation device and a hypothesis generation method capable of generating a wide variety of hypotheses. The present application claims convention priority on Japanese Patent Application No. 2023-049274 filed on Mar. 27, 2023, and incorporates the descriptions of the Japanese application in its entirety.

### BACKGROUND ART

Predicting possible future events has significant meaning in the field of academics, business, politics and so on. Based on such predictions, it becomes possible to make good decisions considering chances and risks of the future.

Such a prediction in the form of sentence or text that can be understood by humans will be referred to as a “hypothesis” in the present specification. Techniques for generating hypotheses are roughly classified into two types. The first is to extract knowledges written by humans from a huge amount of text collected from the web (hereinafter referred to as “web text”) and to form a hypothesis by coupling them. The second is an automatic hypothesis generating technique utilizing deep learning generation technique.

Patent Literature 1 below discloses an example of the first technique. According to the technique of Patent Literature 1, word sequences considered to represent causality by a text pair consisting of “noun+particle+predicate” are collected from a huge amount of Japanese web text. In each word sequence, the preceding text represents cause, and the succeeding text represents effect. If the effect part of a first causality text matches with the cause part of another causality, the cause part of the first causality and the effect part of the second causality are linked to generate a new word sequence. In Patent Literature 1, this word sequence is referred to as a “social scenario.” By repeating this process of linking causalities, a vast number of social scenarios can be generated.

As the second technique, ChatGPT is known. This is related to a language model formed of a neural network trained through so-called deep learning.

Specifically, based on input text, hypotheses are generated by the neural network and output.

### CITATION LIST

### Patent Literature

PTL 1: JP2017-037544A

### Non-Patent Literature

NPL 1: OpenAI, “Introducing ChatGPG”, [online], OpenAI, visited on Mar. 5, 2023, <URL: https://openai.com/blog/chatgpt>

### SUMMARY OF INVENTION

### Technical Problem

Of the above-described conventional techniques, the first technique uses existing data for generating a hypothesis. Therefore, hypotheses with no prior existence are hard to generate, and the generated hypotheses are highly reliable. On the other hand, there arises the question that hypotheses with no prior existence would not be obtained.

On the contrary, by the second technique, a hypothesis is obtained as an output of a generation process. Therefore, an output can be obtained from any input, and the output may possibly be brand new. In the second technique, however, the contents to be output are not at all limited and, therefore, we cannot know what content will be generated until the result is actually obtained. Further, some outputs may be obviously incorrect, decreasing the reliability of outputs. It is also difficult to confirm whether or not the result is proper.

Therefore, an object of the present invention is to provide a hypothesis generation device and a hypothesis generation method that can generate an interesting hypothesis of high reliability that is related to the input contents but not easily conceived.

### Solution to Problem

According to a first aspect, the present invention provides a hypothesis generation device, including: a related text forming unit, responsive to an input text, for generating a related text related to the text; and a hypothesis generation model responsive to the input text and the related text as inputs, trained in advance to generate a hypothesis from the text and the related text.

Preferably, the related text forming unit includes: a question generating unit for generating one or more questions based on the text; and a question-answering unit for searching an existing text archive for passages including an answer to the one or more questions generated by the question generating unit, and outputting the passages as the related texts.

More preferably, the hypothesis generation device further includes a hypothesis consecutive generating unit for having the hypothesis generation model generate a new hypothesis, by inputting the hypothesis generated by the hypothesis generation model in place of the input text to the related text forming unit.

More preferably, the hypothesis generation device further includes: a first selector for selecting and inputting to the related text forming unit either the input text or the hypothesis generated by the hypothesis generation model; and a second selector for selecting, as an input to the hypothesis generation model, either the hypothesis generated by the hypothesis generation model or the input text, and inputting the selected one together with the related text to the hypothesis generation model, to have the hypothesis generation model generate a new hypothesis.

Preferably, hypothesis generation device further includes an input selector for selecting either the input text or the related text generated by the related text forming unit and inputting it into the related text forming unit.

According to a second aspect, the present invention provides a hypothesis generation method, including the steps of: a computer receiving an input of text and forming a related text related to the text; and a hypothesis generation step of the computer providing the text and the related text to a hypothesis generation model trained in advance to generate a hypothesis in response to the text and the related text and thereby generating a new hypothesis.

The foregoing and other objects, features, aspects, and advantages of the present invention will become more apparent from the following detailed description of the present invention when taken in conjunction with the accompanying drawings.

### Advantageous Effects of Invention

The present invention provides a hypothesis generation device and a hypothesis generation method capable of generating interesting hypotheses of high reliability that are related to the input contents but not easily conceived. Further, the related text used in the process of deriving a hypothesis is presented together with the hypothesis and, therefore, it is possible for the user to infer the reason and the evidence from which the hypothesis is generated. A hypothesis of which reason or evidence can be inferred has far higher usability than a hypothesis of which base or evidence is utterly incomprehensible.

### BRIEF DESCRIPTION OF DRAWINGS

FIG. 1 is a block diagram showing a functional configuration of a hypothesis generation system in accordance with a first embodiment of the present invention.

FIG. 2 is a block diagram showing a functional configuration of a related text forming unit shown in FIG. 1.

FIG. 3 is a schematic illustration showing a relation between an input and an output of the hypothesis generating neural network shown in FIG. 1.

FIG. 4 is a block diagram showing a functional configuration of a training data generation system for generating training data for the question generating unit shown in FIG. 2.

FIG. 5 is a block diagram showing a functional configuration of a training data generation system for generating training data for the hypothesis generating neural network shown in FIG. 1.

FIG. 6 is a schematic illustration showing a process for generating inter-sentence semantic relation DB (Data Base) shown in FIG. 5.

FIG. 7 is a schematic illustration showing a process for generating training data, generated by a training data assembling unit shown in FIG. 5.

FIG. 8 is a schematic diagram showing a configuration of the training data and its generation process, in accordance with a modification of the first embodiment.

FIG. 9 is a schematic diagram showing another example of the training data generation process in accordance with a modification of the first embodiment.

FIG. 10 is a block diagram showing a functional configuration of the training data generation system for generating a modification of the training data in accordance with the modification of the first embodiment.

FIG. 11 is a block diagram showing a functional configuration of the related text forming unit used in a second embodiment.

FIG. 12 is a block diagram showing a functional configuration of the related text forming unit used in a third embodiment.

FIG. 13 is a block diagram showing a functional configuration of the hypothesis generation system in accordance with a fourth embodiment.

FIG. 14 is a block diagram showing a functional configuration of the related text forming unit shown in FIG. 13.

FIG. 15 is a block diagram showing a functional configuration of the hypothesis generation system in accordance with a fifth embodiment of the present invention.

FIG. 16 is a block diagram showing a functional configuration of a training data generation system 620 for generating training data of the related text forming unit shown in FIG. 15.

FIG. 17 is a block diagram showing a functional configuration of a training data generation system for generating training data of hypothesis generating neural network in accordance with a fifth embodiment.

FIG. 18 is a block diagram showing a functional configuration of a hypothesis generation system in accordance with a sixth embodiment.

FIG. 19 is a block diagram showing a functional configuration of a hypothesis generation system in accordance with a seventh embodiment.

FIG. 20 is a block diagram showing a functional configuration of a training data generation system for generating training data of hypothesis generating neural network in accordance with an eighth embodiment.

FIG. 21 is a block diagram showing a functional configuration of a training data generation system for generating training data of hypothesis generating neural network in accordance with a ninth embodiment.

FIG. 22 is a block diagram showing a functional configuration of a training data generation system for generating training data of hypothesis generating neural network in accordance with a tenth embodiment.

FIG. 23 is a block diagram showing a functional configuration of a training data generation system for generating training data of hypothesis generating a neural network in accordance with an eleventh embodiment.

FIG. 24 is a schematic illustration showing a configuration of training data for a hypothesis generating neural network in accordance with a twelfth embodiment.

FIG. 25 is a block diagram showing a functional configuration of a similarity calculation model training system used in the eighth, ninth and tenth embodiments.

FIG. 26 is a schematic illustration of a model training method for similarity calculation in the eighth, ninth and tenth embodiments.

FIG. 27 is a block diagram showing a functional configuration of the similarity calculation model training data generating unit shown in FIG. 25.

FIG. 28 is a schematic illustration of the method of calculating similarity in the eighth, ninth and tenth embodiments.

FIG. 29 shows an appearance of a computer realizing the hypothesis generation system and the training data generation system in accordance with various embodiments of the present invention.

FIG. 30 is a block diagram showing a hardware configuration of the computer shown in FIG. 29.

### DESCRIPTION OF EMBODIMENTS

In the following description and in the drawings, the same reference characters denote the same components. Therefore, detailed description thereof will not be repeated.

### 1. First Embodiment

### [Configuration]

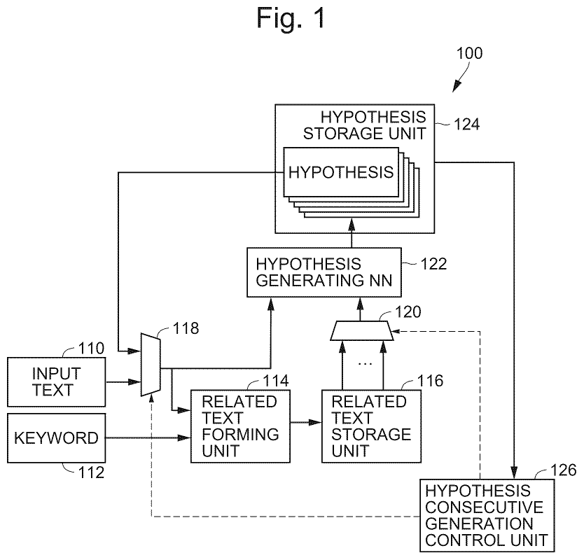

Referring to FIGS. 1 to 7, a hypothesis generation system 100 in accordance with the first embodiment of the present invention will be described. Referring to FIG. 1, hypothesis generation system 100 receives an input text 110 and a keyword 112 as inputs. Though keyword 112 and input text 110 are shown separate from each other in this example, keyword 112 may be extracted from input text 110, as will be described later.

Hypothesis generation system 100 includes: a selector 118 having a first input to receive input text 110 and a second input to receive a hypothesis text that is pre-prepared as will be described later, and selectively outputting input text 110 at the start and thereafter outputting the hypothesis text; a related text forming unit 114 receiving the output of selector 118 and keyword 112 as inputs and based on these, generating a related text related to the text input from selector 118; and a related text storage unit 116 for storing the related text generated by related text forming unit 114.

Hypothesis generation system 100 further includes: a hypothesis generating neural network 122 that is trained beforehand such that based on the input text and any of the related texts stored in related text storage unit 116, a hypothesis is generated and output; a hypothesis storage unit 124 storing the hypotheses output from hypothesis generating neural network 122; and a selector 120 selecting any of a plurality of related texts stored in the related text forming unit 114 and outputting the same as a part of the inputs to hypothesis generating neural network 122. To the second input of selector 118, any of the hypotheses stored in hypothesis storage unit 124 is input. Further, the output of selector 118 is connected to the input of related text forming unit 114 as well as to the input of hypothesis generating neural network 122.

Hypothesis generation system 100 includes a hypothesis consecutive generation control unit 126 for controlling selectors 118 and 120 and hypothesis generating neural network 122 such that, providing that input text 110 is input at the first stage and that hypotheses are output from hypothesis generating neural network 122 at the second and subsequent stages, input text 110 or one of the hypotheses stored in hypothesis storage unit 124, in combination with one of the related text selected by selector 120, is input to hypothesis generating neural network 122 to generate a new hypothesis.

In this example, in any of the multistage repetitions, related text forming unit 114 outputs a plurality of related texts using keyword 112 and the text output from selector 118. The present invention, however, is not limited to such an embodiment. By way of example, input text 110 and keyword 112 may be used as inputs in the first stage, and the hypothesis selected by selector 118 and the keyword extracted from the hypothesis may be used in the second and subsequent stages, to generate a plurality of related texts. Alternatively, in the second and subsequent stages, a hypothesis selected by selector 118, the keyword 112 input at the start and the keyword extracted from the hypothesis may be added to the input.

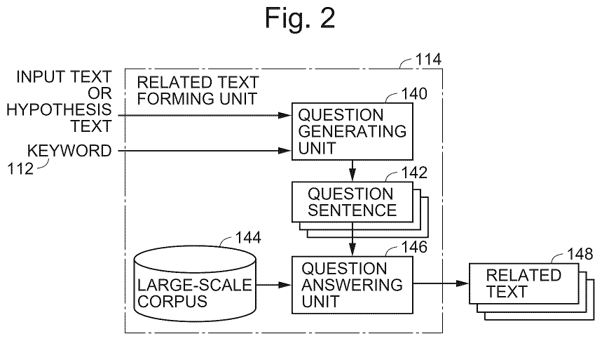

FIG. 2 shows a functional configuration of related text forming unit 114 of FIG. 1. Referring to FIG. 2, related text forming unit 114 includes: a question generating unit 140 using the text output from selector 118 and keyword 112 for generating one or more question sentences 142; a large-scale corpus 144 for storing a huge amount of text collected beforehand from, for example, the web; and a question answering unit 146, searching and extracting, for each question sentence 142, answer passages as passages comprised of one or more sentences including an answer to the question from large-scale corpus 144, ranking and filtering these to retain a passage including an appropriate answer, and outputting the same. The answer passage extracted by question answering unit 146 from large-scale corpus 144 will be the related text 148 for the text input to related text forming unit 114.

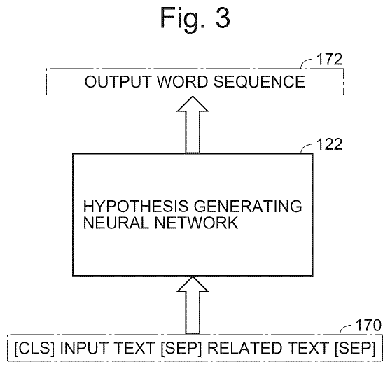

FIG. 3 shows the relation between input and output of hypothesis generating neural network. Referring to FIG. 3, to hypothesis generating neural network 122, a word sequence obtained by concatenating a [CLS] token indicating the head of an input, the text to be input (output from selector 118), [September], related text and [September] token is given as an input 170. It is assumed that each word forming these word sequences is converted to a word ID beforehand. Hypothesis generating neural network 122 is trained in advance such that an output word sequence 172 as a hypothesis is output in response to input 170. The head of output word sequence 172 is a vector corresponding to the [CLS] token. In the present embodiment, this vector is not used.

As the question generating unit 140 shown in FIG. 2, a rule-based one, or one that uses a neural network generation model may be possible. One rule-based method is to replace part of the input text with an interrogative. This method varies language by language. In Japanese, by way of example, by changing a noun in an input text to “who” or “what” or by adding a word sequence such as “why”, “how” or “when” while partially removing noun or noun phrase, a question sentence can be generated.

Alternatively, a question sentence can be generated by adding an interrogative expression to a noun in the input text. The interrogative expression may be “what do you want to do with”, “what does XX do”, “what do you use XX for”, “what do you do with XX”, “what is at XX”, “what is good for XX”, “what is bad for XX”, “how do you do XX”, “how do you use XX”, “why does XX do”, “why does XX use”. By adding such expressions to a noun, question sentences can be generated.

It is also possible to add “with what”, “why”, “how” or “by using what” before the input text, or to add character sequences such as “what happens if”, “what event occurs if”, “what trouble occurs if” after the input text.

To generate a question sentence, it is also possible to apply any of the above-described rules after removing part of the input text. In this case, since part of the input text is removed, the resulting question sentence tends to be more abstract than the one generated from the input text.

In the present embodiment, a generation model formed of a neural network is used as question generating unit 140. As the training data for this model, data prepared as a set of an input and a question obtained from the input and somehow related to the input, may be used. An example may have an input “I like Nagoya” and an output “what sight-seeing spot in Nagoya do you like.”

It is possible to manually prepare the training data. In the present embodiment, however, the training data is formed mechanically on a large scale from, for example, the web. In the present embodiment, the training data for question forming unit 140 is generated in the following manner.

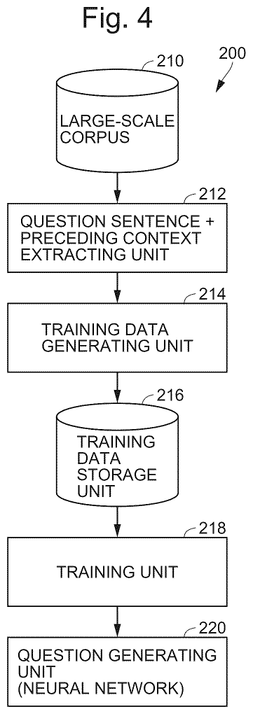

FIG. 4 is a block diagram showing a functional configuration of the training data generation system 200 for generating training vectors for the neural network of question generating unit 220. Referring to FIG. 4, training data generation system 200 includes a large-scale corpus 210, and a question sentence+preceding context extracting unit 212, focusing on a question sentence of a text stored in large-scale corpus 210, for extracting the question sentence and the preceding context comprised of a prescribed number of sentences immediately preceding the question sentence. The method of finding a question sentence differs depending on the object language. For example, in Japanese, a sentence that ends with “KA” may be regarded as a question sentence. In English, a sentence that begins with “Do” or “Does” may be regarded as a question sentence.

Training data generation system 200 further includes: a training data generating unit 214 for generating the training data from each of the sets of question sentence and preceding context extracted by question sentence+preceding context extracting unit 212; a training data storage unit 216 for storing the training data generated by training data generating unit 214; and a training unit 218 for training question generating unit 220 using the training data stored in training data storage unit 216.

Assume, for example, that there is a sentence “What does it mean to have cold-like symptoms and feel feverish, but have no fever?” Further assume that immediately preceding this sentence, there are the following sentences as preceding context: “I thought it was strange and measured it several times, but it remained at 36.5 to 37 degrees Celsius. My body is also very painful, I have no appetite and fatigue is so bad that I can't even go to work. It is hard to get up and I have not been able to go to the hospital.” In this case, the training data is generated using the former, that is, the question, as an output, and the latter, that is, the preceding context, as an input.

The configuration of the training data for question generating unit 220 is a pair of a preceding context of the question and the question sentence. Specifically, parameters of question generating unit 220 are trained such that the output of question generating unit 220 when the preceding context is input to question generating unit 220 generates a question sentence that follows the preceding context.

There are various other methods of automatically generating question sentences using text including questions. In addition to the training data described above, it is also possible to automatically extract part of expressions (such as nouns) included in the output and to add it to the input. By doing this, the neural network can be trained such that it generates a question including an expression given in the input. Alternatively, the type of a question (why-type, what-type, how-type etc.) may be specified beforehand and information designating the question type may be added to the input. This makes it possible to train question generating unit 220 such that it generates questions of a specific type. In this case, inputs to question generating unit 220 may be formed with respect to respective ones of a plurality of question types so that different types of questions are generated from one input text.

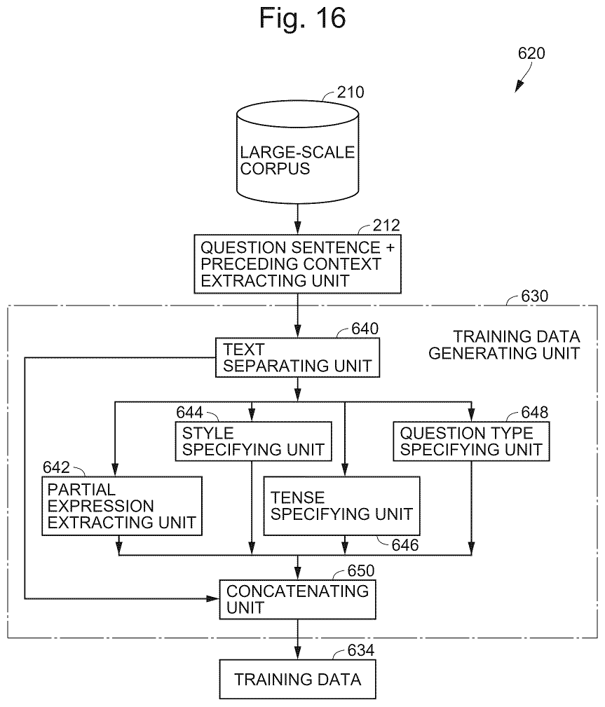

As to the question types, in addition to the above, description styles (common/honorific language), tense (verb form. past tense or not), whether or not a personal pronoun is included, or whether it is a request or not, may be considered as possible question types. Such question types may be added to the input with, for example, a specific keyword. Details of this process will be discussed later with reference to FIG. 16.

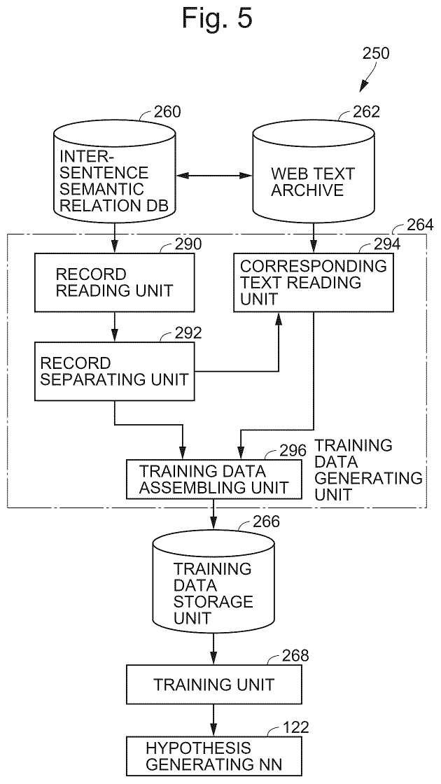

FIG. 5 shows a configuration of the training data generation system 250 for generating training data for hypothesis generating neural network 122. Referring to FIG. 5, training data generation system 250 includes: a web text archive 262 containing a huge amount of web text collected beforehand from the web; and an inter-sentence semantic relation DB 260 for storing a large number of text pairs representing prescribed inter-sentence semantic relations, generated from word sequence pairs representing causality extracted beforehand from web text archive 262 and text passages including these and subjected to processes such as reformatting and complementing of omitted parts. The inter-sentence semantic relation refers to a specific relation between a pair of texts consisting of two texts, similar to the causality mentioned above. Examples of the relation includes solution relation (the first text is a problem and the second text is a solution to the problem) and a goal-event/action/state relation (the first text is a goal, and the second text is an event, operation, or state for the goal).

Each text pair included in the inter-sentence semantic relation DB 260 is extracted from web text archive 262, and each text pair of inter-sentence semantic relation DB 260 has a piece of access information to the corresponding portion of web text archive 262.

Training data generation system 250 further includes: a training data generating unit 264 extracting, for each of the text pairs in the inter-sentence semantic relation DB 260, the passage including the text pair from web text archive 262 using the access information added to the text pair, and for generating, from the original text pair and the extracted passage, training data for hypothesis generating neural network 122. The training data generated by training data generating unit 264 is stored in a training data storage unit 266. Training unit 268 reads the training data from training data storage unit 266 and trains hypothesis generating neural network 122.

Training data generating unit 264 includes: a record reading unit 290 for reading a record including each text pair from inter-sentence semantic relation DB 260; a record separating unit 292 for separating the record read by record reading unit 290 to the first text, the second text and the access information; a corresponding text reading unit 294, using the access information output from record separating unit 292, for reading the passage including the text pair from web text archive 262; and a training data assembling unit 296 using the first text and the second text output from record separating unit 292 and the passage output from corresponding text reading unit 294, for assembling training data and outputting the same.

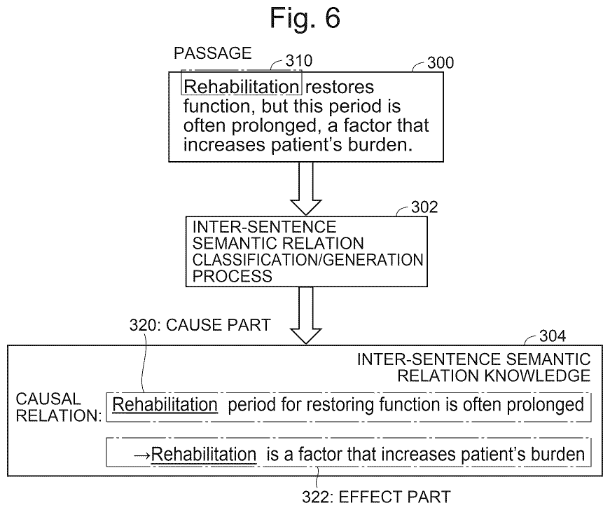

FIG. 6 shows a specific example of the record of inter-sentence semantic relation DB 260 and the web text in the web text archive 262. Referring to FIG. 6, assume, for example, that there is a passage 300 in web text archive 262. By executing an inter-sentence semantic relation classification/generation process 302 by, for example, a pre-trained neural network, inter-sentence semantic relation knowledge 304 is obtained.

Inter-sentence semantic relation knowledge 304 extracts, for example, a text pair that has causality relation, from passage 300. By complementing omitted parts on each of these texts manually or automatically, for example, by supplementing a character sequence 310 in passage 300 as a subject, inter-sentence semantic relation knowledge 304 related to causality, consisting of cause part 320 and effect part 322 is obtained. The same applies to other inter-sentence relations.

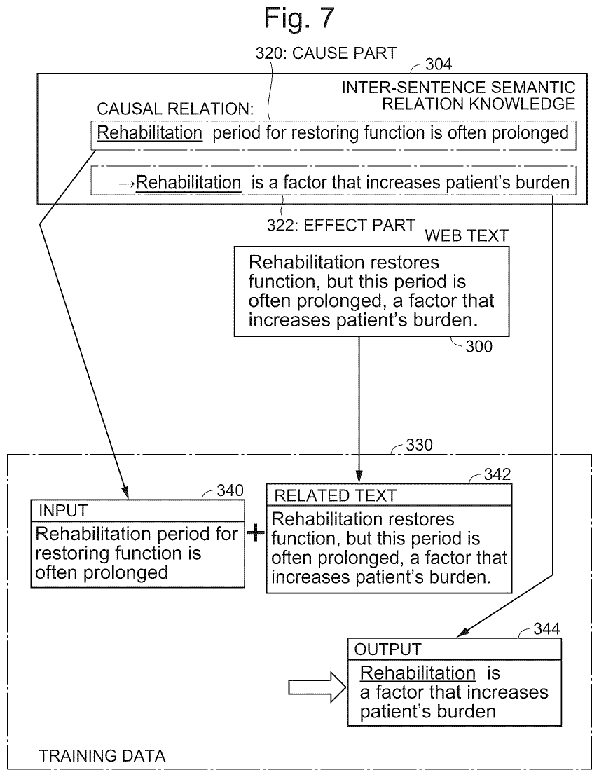

FIG. 7 schematically shows the process of obtaining training data 330 from inter-sentence semantic relation knowledge 304 and the passage 300 extracted from the web text. Referring to FIG. 7, cause part 320 of inter-sentence semantic relation knowledge 304 will be the input 340 of training data 330. Passage 300 will be the related text 342 of training data 330. The effect part 322 of inter-sentence semantic relation knowledge 304 will be the output 344 of training data 330.

[Operation]

Hypothesis generation system 100 in accordance with the first embodiment above operates in the following manner. Referring to FIG. 1, hypothesis consecutive generation control unit 126 controls selector 118 such that selector 118 first selects the input to the first input. As a result, input text 110 and keyword 112 are input to hypothesis generation system 100. Keyword 112 is input to related text forming unit 114, and input text 110 is input to the related text forming unit and to the first input of selector 118.

Referring to FIG. 2, based on the input text 110 and the keyword 112, question generating unit 140 generates one or more question sentences 142 and applies these to question answering unit 146. For each of the given one or more question sentences 142, question answering unit 146 extracts one or more answer passages including an answer to the question from large-scale corpus 144, and outputs the same as related text 148.

Hypothesis consecutive generation control unit 126 controls selector 120 such that selector 120 selects the first related text of related text storage unit 116, and a word sequence obtained by concatenating the outputs of selectors 118 and 120 is input to hypothesis generating neural network 122. Here, at the beginning of input word sequence, a [CLS] token is added, a [September] token for separation is inserted between the outputs of selectors 118 and 120, and at the end of the output of selector 120, the same [September] token is added.

The word sequence output by hypothesis generating neural network 122 in response to this input is stored in hypothesis storage unit 124. A plurality of outputs may be selected, as outputs of hypothesis generating neural network 122. Similar process is repeated while switching the related text selected by selector 120. When the above-described process is done on every related text stored in related text storage unit 116, the process of the first stage ends.

In the second stage, hypothesis consecutive generation control unit 126 controls selectors 118 and 120 such that selector 118 selects the second input and selector 120 selects the second related text. Selector 118 selects the first hypothesis stored in hypothesis storage unit 124 and inputs it to related text forming unit 114. Based on this hypothesis text and keyword 112, related text forming unit 114 forms a plurality of related texts as in the first stage, and outputs these to related text storage unit 116. Selector 120 selects and outputs, of the related texts stored in related text storage unit 116, the related text at the head. A word sequence obtained by concatenating the hypothesis text output from selector 118 and the related text output from selector 120 is input to hypothesis generating neural network 122, and the output of hypothesis generating neural network 122 is stored in hypothesis storage unit 124. Thereafter, the above-described process is repeated to use every related text stored in related text storage unit 116.

When all the related text stored in related text storage unit 116 is used up, hypothesis consecutive generation control unit 126 controls selector 118 such that selector 118 selects the second hypothesis stored in hypothesis storage unit 124. The second hypothesis text is input to related text forming unit 114, and a plurality of related texts are formed and stored in related text storage unit 116. Hypothesis consecutive generation control unit 126 controls selector 120 such that selector 120 selects and outputs the first related text in related text storage unit 116. The outputs of selectors 118 and 120 are concatenated and given to hypothesis generating neural network 122. The output of hypothesis generating neural network 122 is stored as a new hypothesis in hypothesis storage unit 124. Thereafter, hypothesis consecutive generating unit 126 controls selector 120 such that selector 120 selects the second related text and executes the above-described process.

In this manner, for each hypothesis stored in hypothesis storage unit 124, a related text generated from the hypothesis and keyword 112 is formed. Then, the hypothesis and every related text stored in related text storage unit 116 are combined and new hypotheses are generated. This process is repeated.

The above-described process is performed and generation of hypotheses is terminated when a prescribed end condition is satisfied. The termination condition may be that the number of generated hypotheses exceeds a prescribed number.

As described above, according to the present embodiment, input text 110 having keyword 112 added is given to hypothesis generation system 100, and related text forming unit 114 generates a plurality of related texts based on keyword 112. The related text added to input text 110 is input to hypothesis generating neural network 122. From this experiment, it was found that interesting hypotheses not easily predictable from the inputs could be obtained. Further, there was a tendency that, when a specific keyword was input, hypotheses including the keyword were generated more frequently. Further, it is possible to know the evidences for generation of these hypotheses. Specifically, in order to generate each hypothesis, a related text is obtained from the web through question-answering, and by utilizing this, the hypothesis is generated. As a result, it becomes possible to confirm, by the related text used at the time of forming the hypothesis, why the eventually generated hypothesis resulted. Consequently, each hypothesis comes to have higher reliability.

### 1A. First Modification

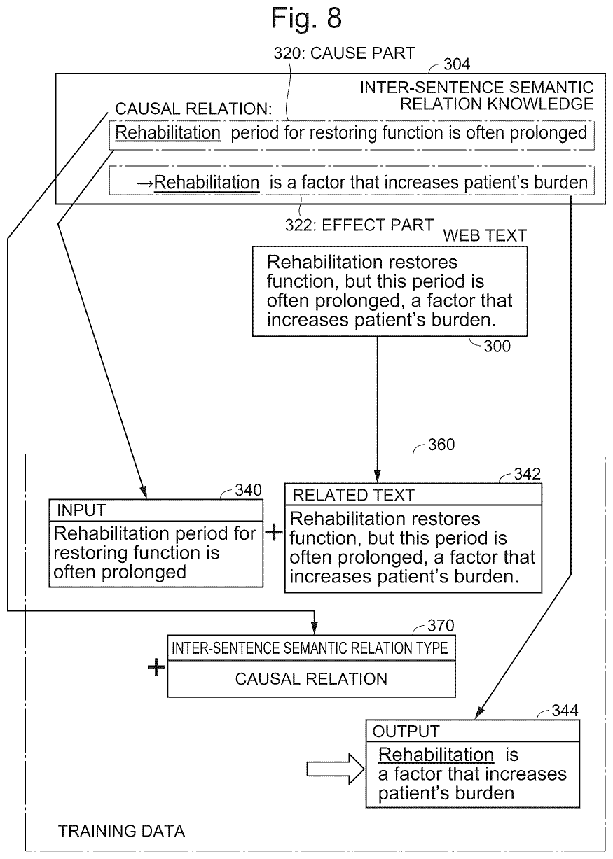

In the first embodiment described above, for the training of hypothesis generating neural network 122, training data, which is formed of a word sequence as an input, a word sequence of related text and a word sequence to be the output, is used as shown in FIG. 7. The present invention, however, is not limited to such an embodiment. To the training data, information indicating the type (such as causality, solution relation, goal-event/action/status relation, and the like) of inter-sentence semantic relation knowledge 304 from which input 340 and output 344 are obtained may be added. FIG. 8 shows the process of generating the training data for this purpose.

Referring to FIG. 8, in this modification, training data 360 includes an input 340 consisting of a cause part 320 of inter-sentence semantic relation knowledge 304, related text 342 and inter-sentence semantic relation type 370, and an output 344. The combination of related text 342 and inter-sentence semantic relation type 370 functions as the related text.

When hypothesis generating neural network 122 is to be trained in this manner, as the input at the time of generating a hypothesis, it is necessary to include, as in the first embodiment, input text 110 shown in FIG. 1 and the related text, and in addition, a word or symbol indicating a semantic relation. As the semantic relation here, the user may determine it at the time of hypothesis generation and constantly add the same value (for example, a symbol indicating causality) to the input, or add an arbitrary value representing a semantic relation to the input at the time of hypothesis generation. In the former case, hypotheses based on the relation in accordance with the value determined at the time of hypothesis generation can be obtained, and in the latter case, it becomes more likely that hypotheses of wider varieties are obtained.

### 1B. Second Modification

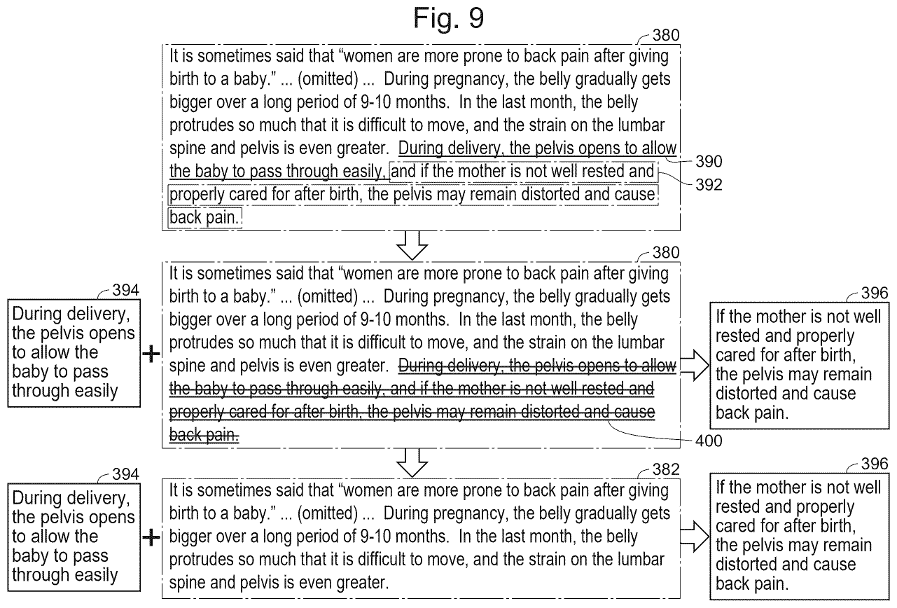

The method of generating the training data for the hypothesis generating neural network is not limited to the first embodiment and the first modification above. By way of example, a method such as shown in FIG. 9 is also possible. Referring to FIG. 9, assume that in the web text archive, a passage 380 including a cause part 394 and an effect part 396 of a causality exists. In passage 380, text 390 corresponding to the cause part 394 and text 392 corresponding to effect part 396 exist.

In generating the training data, this passage 380 may be used as the related text for the cause part 394 and the effect part 396. When such training data is used, it is possible to learn the process in which cause part 394 and passage 380 are used as inputs and effect part 396 is extracted. As a result, if a cause part and an effect part are included in a passage, by inputting the passage as the related text together with the cause part to generate a hypothesis, it becomes more likely that the effect part is obtained as the output.

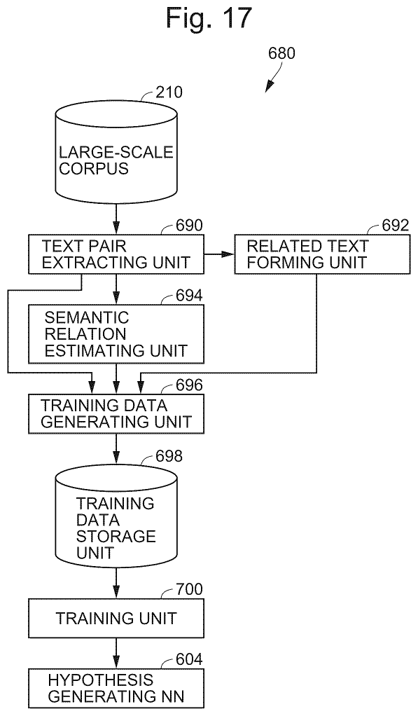

FIG. 17 shows an example of the system for generating training data that allows the hypothesis generating network to execute such a process. Referring to FIG. 17, training data generation system 680 includes: a large-scale corpus 210 storing a huge amount of text, such as web text archive; and a text pair extracting unit 690 extracting, from large-scale corpus 210, text pairs having a specific relation with each other (for example, texts 390 and 392 shown in FIG. 9) and passages (passage 380 shown in FIG. 9) including the text pairs, ranking these, and filtering to retain passages including appropriate answers and outputting the result. Here, the specific relation refers to causality, solution relation, goal-event/action/state relation and so on.

Training data generation system 680 further includes: a semantic relation estimating unit 694 estimating a semantic relation between two texts forming a text pair extracted by text pair extracting unit 690; and a related text forming unit 692 for generating a related text, using the passage 380 extracted by text pair extracting unit 690. Though related text forming unit 692 is said to generate a related text, here, it uses the extracted passage 380 as it is.

Training data generation system 680 further includes a training data generating unit 696 that uses, from the text pair extracted by text pair extracting unit 690, the first sentence (in the case of causality, causes part) as an input, the extracted passage as the related text and the second sentence (in the case of causality, effect part) as an output and, by concatenating these, generates training data. The training data output from training data generating unit 696 is stored in training data storage unit 698, and training unit 700 trains hypothesis generating neural network 604 using the training data. Thus, hypothesis generating neural network 604 learns the process of generating, in response to an input, a sentence that is included in the related text and corresponds to the output.

Returning to FIG. 9, in passage 380, text 400 consisting of texts 390 and 392 corresponding to cause part 394 and effect part 396 may be deleted. The resulting passage 382 is used as the related text and hypothesis generating neural network 604 is trained. With such training data, hypothesis generating neural network 604 can be trained to output, based on input+related text, content (effect corresponding to the input) not described in any of these.

### 1C. Third Modification

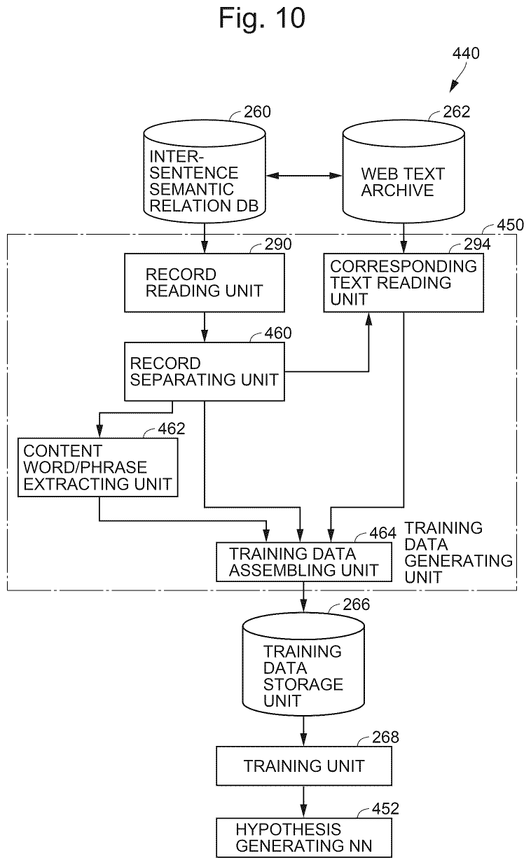

The training data for the hypothesis generating neural network is not limited to the above. For instance, a content word or a phrase included in the output part of training data may be added to the input as a related text. FIG. 10 shows a functional configuration of a training data generation system 440 generating training data for a hypothesis generating neural network 452 that learns in such a manner.

Referring to FIG. 10, training data generation system 440 includes: a web text archive 262; inter-sentence semantic relation DB 260; and a training data generating unit 450 for generating training data for the hypothesis generating neural network 452 using contents stored in these.

Training data generating unit 450 includes: a record reading unit 290; a record separating unit 460 for separating a record representing inter-sentence semantic relation read from inter-sentence semantic relation DB 260 by record reading unit 290, to a cause part, an effect part and a piece of access information; a corresponding text reading unit 294 using the access information output from record separating unit 460, for reading corresponding text as a passage including an expression of causality that is being processed, from web text archive 262; a content word/phrase extracting unit 462 extracting, from the second text output by record separating unit 460, a content word or phrase included in the second text; and a training data assembling unit 464, using the first and second texts output from record separating unit 460, the word/phrase output by content word/phrase extracting unit 462 and the passage output from corresponding text reading unit 294, for assembling and outputting training data.

The training data generated in this manner is stored in training data storage unit 266. Training unit 268 trains hypothesis generating neural network 452 using the training data. When a hypothesis is generated by hypothesis generating neural network 452, input text 110 that is the same as that shown in FIG. 1 and keyword 112 are received and a related text is generated, and then, input text 110, the related text, and keyword 112 are input to hypothesis generating neural network 452. As a result, a hypothesis is obtained as an output of hypothesis generating neural network 452. Here, a keyword different from keyword 112 may be input by a user.

By this modification, for example, when result of hypotheses generation related to “fishing” is particularly desirable, it is possible to train hypothesis generating neural network 452 by including a keyword “fishing.” As a result, when hypotheses of a specific field are particularly wanted, it is possible to efficiently get hypotheses of the desired field.

### 2. Second Embodiment

In the first embodiment above, related text forming unit 114 shown in FIG. 1 generates a question 142 by question generating unit 140 using a neural network, as shown in FIG. 2. The present invention, however, is not limited to such an embodiment.

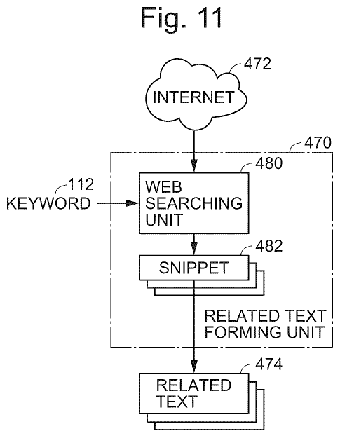

FIG. 11 shows a functional configuration of a related text forming unit 470 that can be used in place of related text forming unit 114 shown in FIG. 2 in the hypothesis generation system in accordance with the second embodiment. Referring to FIG. 11, related text forming unit 470 includes a web searching unit 480 searching the web on Internet 472 using the input keyword 112 as a key, for collecting snippets 482 consisting of a plurality of sentences including the keyword 112. In the second embodiment, snippets 482 are used as related text 474.

By such an embodiment also, the same functions and effects as the first embodiment can be attained.

### 3. Third Embodiment

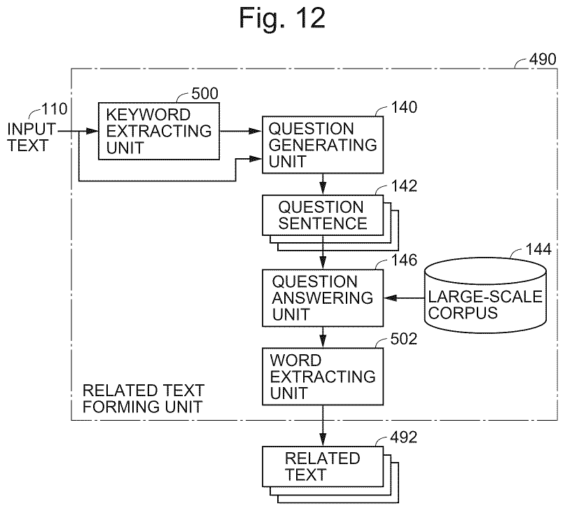

FIG. 12 shows a still another example of related text forming unit 490 used in the hypothesis generation system in accordance with the third embodiment of the present invention. The hypothesis generation system in accordance with the present invention can also be realized by using the related text forming unit 490 in place of related text forming unit 114 shown in FIG. 1.

Referring to FIG. 12, related text forming unit 490 includes: a keyword extracting unit 500 for extracting a keyword from input text 110 (see FIG. 1); question generating unit 140 for generating one or more questions 142 based on the keyword extracted by keyword extracting unit 500; a question-answering unit 146 for extracting a passage including an answer to the question from large-scale corpus 144 using each of the questions 142; and a word extracting unit 502 extracting a content word or phrase from each of the passages including the answer extracted by question-answering unit 146. The word or phrase extracted by word extracting unit 502 is used as related text 492.

In this embodiment also, as in the first embodiment, it is possible to add to the input a word or phrase as its related text, to be input to the hypothesis generating neural network. As a result, the same effects as the first embodiment can be attained.

### 4. Fourth Embodiment

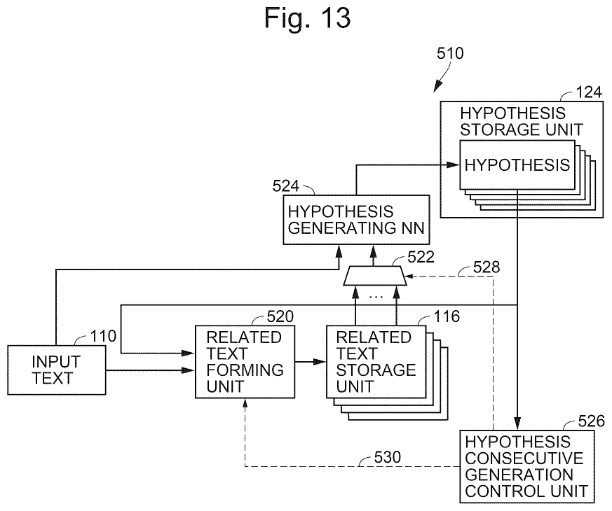

FIG. 13 shows a functional configuration of a hypothesis generation system 510 in accordance with the fourth embodiment of the present invention. Referring to FIG. 13, hypothesis generation system 510 includes: a related text forming unit 520 receiving input of input text 110 for generating and outputting related text; related text storage unit 116 for storing related text generated by related text forming unit 520; a selector 522 for selecting one by one the plurality of texts stored in related text storage unit 116; and a pre-trained hypothesis generating neural network 524 receiving an input obtained by concatenating input text 110 and the output of selector 522, for generating and outputting a hypothesis for input text 110.

Hypothesis generation system 510 further includes: a hypothesis storage unit 124 for storing a plurality of hypotheses output from hypothesis generating neural network 524; and a hypothesis consecutive generation control unit 526 for operating control 530 of related text forming unit 520 and control 528 of selector 522 such that by controlling hypotheses generation by hypothesis generating neural network 524, related text generation by related text forming unit 520 and selection of related text by selector 522, related texts are generated from input text 110 only, from each of the plurality of hypotheses stored in hypothesis storage unit 124 and input text 110, or from each of the hypotheses, and the related texts and input text are combined and input to hypothesis generating neural network 524 to further generate new hypotheses.

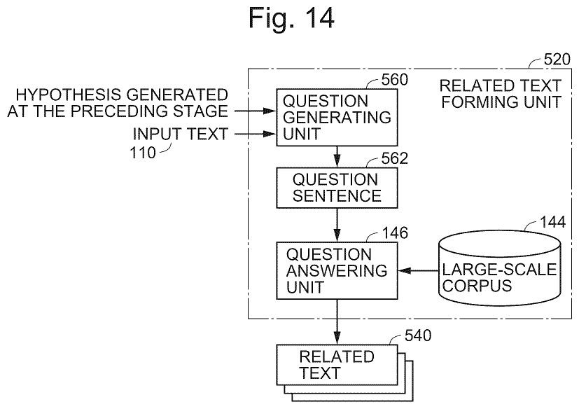

Referring to FIG. 14, related text forming unit 520 includes: a question generating unit 560 that receives hypotheses generated so far and input text 110 as inputs, and by combining these, generates a new question sentence 562; and a question-answering unit 146 that searches in large-scale corpus 144 for passages including an answer to question sentence 562, extracts answer passages including an answer to question sentence 562 from large-scale corpus 144, ranks and filters these to retain a passage including an appropriate answer and outputs it as related text 540.

Various methods may be possible to generate question 562 in question generating unit 560. Assume that input text 110 is “global warming is advancing” and one of the hypotheses generated in the preceding stage of processing is “sea temperature is rising.” One example of questions obtained by combining these may be “Why global warming is advancing and sea temperature is rising?” Generation of such a question can be done simply by adding the character sequence “Why” at the end. Questions of other forms can be generated in the equivalent manner.

When, for example, a hypothesis is not yet generated, related text forming unit 520 generates a question sentence using input text 110 only. After a hypothesis is generated, it generates a question sentence by combining the newly generated hypothesis with the input text 110.

By generating a question sentence in this manner, question sentence 562 given to question-answering unit 146 becomes a question having a clearer object. As a result, the related text searched and extracted from large-scale corpus 144 by question-answering unit 146 possibly comes to have higher relevance to the input.

### 5. Fifth Embodiment

As described above, by the hypothesis generation system in accordance with the present invention, a plurality of hypotheses can be obtained based on one input. In the embodiments above, the relation between such hypotheses cannot be clearly specified. There may be such a relation that based on a preceding hypothesis, a succeeding hypothesis is generated. Even in such a case, it is not always possible to find a clear relation or connection among a series of generated hypotheses when seeing them all together.

If there is a storyline, such as a line of inference or argument among a series of hypotheses, the series of hypotheses would have increased persuasiveness. For this purpose, a concept of category is introduced in the fifth embodiment.

In the present embodiment, “category” represents transition of hypotheses contents between preceding and succeeding hypotheses, and it designates semantic relation, line of inference, line of topic and the like. An example is “continuation,” “contrast” and “exemplification.” By generating a series of hypotheses successively while designating transition of hypotheses such as “continuation→contrast→exemplification,” it becomes possible to develop a storyline along the series of hypotheses. As a result, it may be possible to generate more interesting hypotheses having a story with a climax.

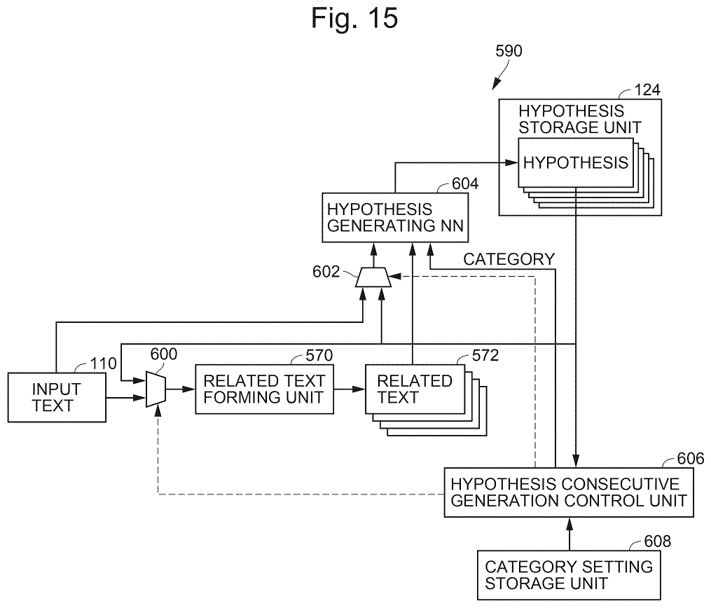

FIG. 15 shows a functional configuration of a hypothesis generation system 590 in accordance with the fifth embodiment. Referring to FIG. 15, hypothesis generation system 590 includes: a selector 600 having a first input for receiving input text 110 and a second input for receiving another word sequence different from input 110 (a hypothesis generated by the process up to the preceding stage); a related text forming unit 570 connected to receive an output of selector 600, for generating, based on the input, related text for the input; a related text storage unit 572 for storing related text generated by related text forming unit 570; a hypothesis generating neural network 604;

and a hypothesis storage unit 124 for storing the hypotheses output by hypothesis generating neural network 604. In the present embodiment, keyword input is not used. The present invention, however, is not limited to such an embodiment and, as in the first embodiment, a keyword may be input in addition to input text 110, and it may be used by related text forming unit 570 forming the related text.

The configuration of related text forming unit 570 is the same as that of related text forming unit 114 shown in FIG. 2. The present embodiment, however, is different from the first embodiment in the configuration of the training data for the neural network that forms the question generating unit 140. This point will be discussed later.

Hypothesis generation system 590 further includes: a selector 602 selecting either the first input receiving the input text 110 or one of the hypotheses newly stored in hypothesis storage unit 124 and applying the selected one to the input of hypothesis generating neural network 604; a category setting storage unit 608 for storing a category sequence to be set successively on generated hypotheses; and a hypothesis consecutive generation control unit 606 causing, every time a new hypothesis is stored in hypothesis storage unit 124, selectors 600 and 602 to select an input in accordance with the stage of processing, and to have a piece of information indicating the corresponding category (category information) among the category sequences stored in category setting storage unit 608 to the input of hypothesis generating neural network 604.

To hypothesis generating neural network 604, the output of selector 602 (input text 110 or newly generated hypothesis), one of the related texts stored in related text storage unit 572, and the category information from hypothesis consecutive generation control unit 606 are given.

In related text storage unit 572, a plurality of related texts is stored. Though not shown in FIG. 15, at the output of related text storage unit 572, a selector is provided for selecting and applying to hypothesis generating neural network 604, one of the related texts stored in related text storage unit 572. The selector is controlled by hypothesis consecutive generation control unit 606 and, for example, when the hypothesis selected by selector 600 is switched, it selects one by one the related text stored in related text storage unit 572 and applies to hypothesis generating neural network 604. By this process, when a new hypothesis is generated, at least the same number of hypotheses as the related text stored in related text storage unit 572 come to be newly generated and stored in hypothesis storage unit 124.

FIG. 16 shows a functional configuration of training data generation system 620 that generates training data for the neural network for generating question sentences, included in related text forming unit 570 shown in FIG. 15. Referring to FIG. 16, training data generation system 620 includes: a question sentence+preceding context extracting unit 212 for extracting, from large-scale corpus 210, a question sentence and its preceding context; and a training data generating unit 630 for generating, from the question sentence and its preceding context extracted by question sentence+preceding context extracting unit 212, the training data for the question sentence generating neural network. Configurations of large-scale corpus 210 and question sentence+preceding context extracting unit 212 are the same as those shown in FIG. 4.

Training data generating unit 630 includes: a text separating unit 640 for separating texts of question sentence and preceding context extracted by question sentence+preceding context extracting unit 212; a partial expression extracting unit 642, receiving the question sentence from the text separated by text separating unit 640, for automatically extracting part of its expression and outputting an expression with the part replaced by a variable; a style specifying unit 644 specifying the style (common/honorific language etc.) of the text expression of the question sentence, and outputting a piece of information representing the style; a tense specifying unit 646 for specifying tense (verb form) of the question sentence and outputting a piece of information representing the tense; a question type specifying unit 648 for specifying the type of the question sentence (why, what, how type etc.) and outputting a piece of information representing the question type; and a concatenating unit 650 for concatenating the output of partial expression extracting unit 642, the output of style specifying unit 644, the output of tense specifying unit 646, the output of question type specifying unit 648, and the preceding context with [September] tokens in between, and further concatenating the thus coupled preceding context and the question sentence, and outputting the result as training data 634.

When various pieces of information are added to the preceding context, at the time of actual generation of a question, by adding the above-mentioned pieces of information with desired specific values to the input, it becomes possible to make the neural network generate a question including an intended expression, a question of an intended style, a question of an intended type, a question of an intended tense and so on. FIG. 16 shows an example in which values designating respective categories are combined. These categories, however, are independent from each other. Therefore, when training data is to be formed, only a part of these values representing categories may be specified.

It is also possible to extract, for example, a noun from the question extracted by question sentence+preceding context extracting unit 212 and to add it to the preceding context. By doing this, it becomes possible for the question generating neural network to generate a question including the noun in the input. Further, in addition to the pieces of information mentioned above, pieces of information such as whether to include a personal pronoun in the question or not, whether the question is to be a request type, may be added to the preceding context.

### 6. Sixth Embodiment

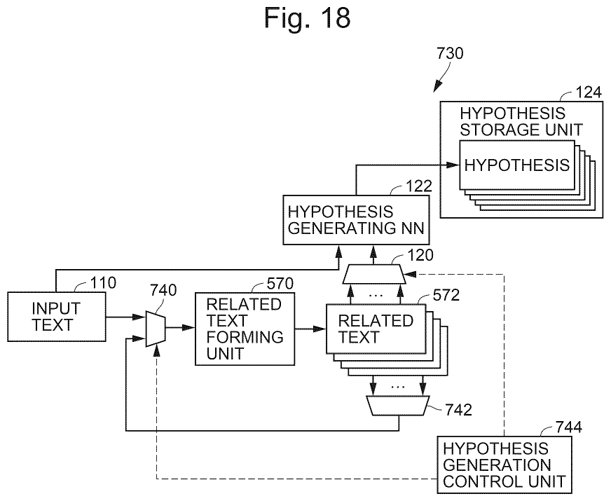

FIG. 18 shows a functional configuration of a hypothesis generation system 730 in accordance with the sixth embodiment of the present invention. Hypothesis generation system 730 repeatedly executes the process of receiving input text 110, generating related text at first and, thereafter, generates a new related text based on the generated related text. When a prescribed end condition is met, for example, when a prescribed number of related texts have been generated, input text 110 is combined with each of the generated related texts and input to hypothesis generating neural network 122. By such a process, long hypotheses can be generated.

Referring to FIG. 18, hypothesis generation system 730 includes: a selector 740 having a first input receiving input text 110 and a second input; related text forming unit 570 receiving an output of selector 740 and based on the output of selector 740, generating one or more related texts; and related text storage unit 572 for storing related text generated by related text forming unit 570. Configurations of related text forming unit 570 and related text storage unit 572 are the same as those shown in FIG. 15.

Hypothesis generation system 730 further includes: a selector 742 selecting one of the related texts stored in related text storage unit 572 and giving it to the second input of selector 740 and thereby causing related text forming unit 570 to generate a new related text; a selector 120 for successively selecting and outputting, after generation of related text by related text forming unit 570 is completed, the related text stored in related text storage unit 572; hypothesis generating neural network 122 trained in advance to receive an input obtained by coupling input text 110 and the output of selector 120 and to generate a hypothesis; hypothesis storage unit 124 for storing the hypotheses generated by hypothesis generating neural network 122; and a hypothesis generation control unit 744 controlling selectors 740 and 120 to select appropriate inputs in the first hypothesis generation cycle and subsequent cycles, so that hypothesis generating neural network generates hypotheses repeatedly. In the present embodiment, the process of obtaining a plurality of related texts from one related text is repeated. By this process, the related texts come to have a tree-like relation and to be wider. As will be described later, in hypotheses generation, a series of related texts positioned along a path from the point corresponding to the root of the tree to the leaves are linked, and a long hypothesis is generated therefrom. Therefore, in related text storage unit 572, for each related text, a piece of information indicating from which input the related text is obtained, that is, whether the related text is obtained using input text 110 or using any of the plurality of related text, is also maintained.

In the present embodiment, in the first cycle of hypothesis generation, selector 740 selects input text 110 and inputs this to related text forming unit 570. In response to input text 110, related text forming unit 570 generates one or more related texts. Related text storage unit 570 stores the one or more related texts. When generation of related text from input text 110 ends, selector 742 selects the plurality of related texts one by one successively and applies to the second input of selector 740. Selector 740 inputs the related text to related text forming unit 570. As a result, one or more related texts are newly stored in related text storage unit 572.

When this process of forming new related texts by using related text stored in related text storage unit 572 is repeated, the number of related text stored in related text storage unit 572 eventually exceeds a prescribed number. Then, selector 742 stops selection of the new related text.

When selection of the new related text by selector 742 ends, selector 120 selects, of the related text stored in related text storage unit 572, the paths from the root to each leaf of the above-mentioned tree one by one and successively selects the related texts on the paths. That is, the related texts on each path are linked and input together with the input text 110, to the hypothesis generating neural network 122. Hypothesis generating neural network 122 generates new hypotheses, using input text 110 and related text successively output by selector 120 as inputs. The new hypotheses will be a long hypothesis obtained based on mutually linked related texts.

When hypothesis generating neural network 122 generates a hypothesis using all the mutually linked related texts stored in related text storage unit 572, hypothesis generation by hypothesis generation system 730 ends.

By the hypothesis generation system 730, after a plurality of related texts are generated at first, hypotheses come to be generated from the combinations of each of the plurality of related texts and input text 110. As a result, it becomes possible to generate a long hypothesis by a simple process.

### 7. Seventh Embodiment

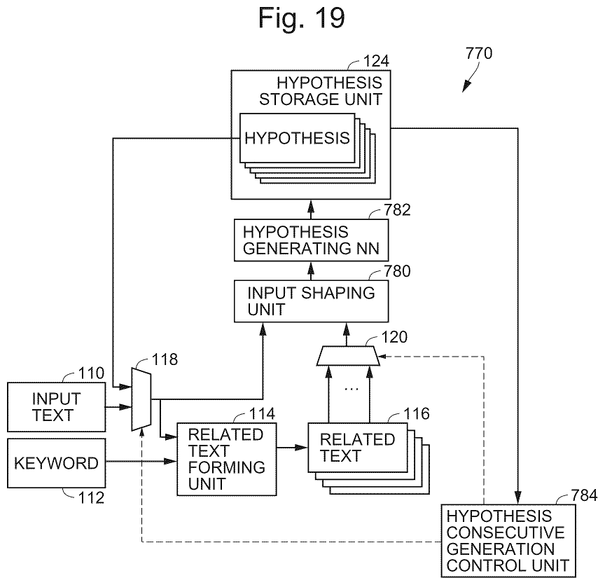

FIG. 19 shows a functional configuration of a hypothesis generation system 770 in accordance with the seventh embodiment of the present invention. Referring to FIG. 19, hypothesis generation system 770 includes: related text forming unit 114, related text storage unit 116, selectors 118 and 120 and hypothesis storage unit 124, similar to those shown in FIG. 1, and it further includes: an input shaping unit 780 for combining outputs of selectors 118 and 120 to form one sentence; a hypothesis generating neural network 782 having the same function as hypothesis generating neural network 122 shown in FIG. 1 but further configure to receive the sentence shaped by input shaping unit 780 as an input to generate a hypothesis; and a hypothesis consecutive generation control unit 784, for controlling various units, including selectors 118 and 120, of hypothesis generation system 770 such that hypothesis generation system 770 generates a plurality of hypotheses in response to input of input text 110 and keyword 112.

Hypothesis generation system 770 differs from hypothesis generation system 100 shown in FIG. 1 in that the form of input to hypothesis generating neural network 782 is different from that to hypothesis generation network 112 of FIG. 1, and that, for this purpose, input shaping unit 780 is provided. Except for these points, hypothesis generation system 770 has the same structure as hypothesis generation system 100.

The input to hypothesis generation network 122 shown in FIG. 1 is [CLS]+word sequence of input text 110+[September]+word sequence of related text+[September]. In contrast, input shaping unit 780 concatenates input text 110 and related text from selector 120 to form a natural sentence, which will be an input to hypothesis generation network 782. For example, input shaping unit 780 combines input text 110 with the related text from selector 120 to generate a word sequence “[CLS]+word sequence of related text+“GA,”+word sequence of input text 110+[September]”, and inputs this to neural network 782.

Assume, as an example, that the input text 110 is “develop a dialogue system” keyword 112 is “elderly person,” and related text “elderly person has difficulty in finding means of transportation” is obtained. Input shaping unit 780 concatenates and shapes these two sentences to generate a sentence “elderly person has difficulty in finding means of transportation, so develop a dialogue system”, which is input to hypothesis generating neural network 782.

In order for hypothesis generating neural network 782 to generate hypotheses based on such inputs, it is necessary that the training data has the same format as the output of the above-described input shaping unit 780. Specifically, at the time of training also, it is necessary to store the related text storage unit 116, to couple this with input text 110 to form one sentence, and provide this one sentence as an input to hypothesis generating neural network 782.

### 8. Eighth Embodiment

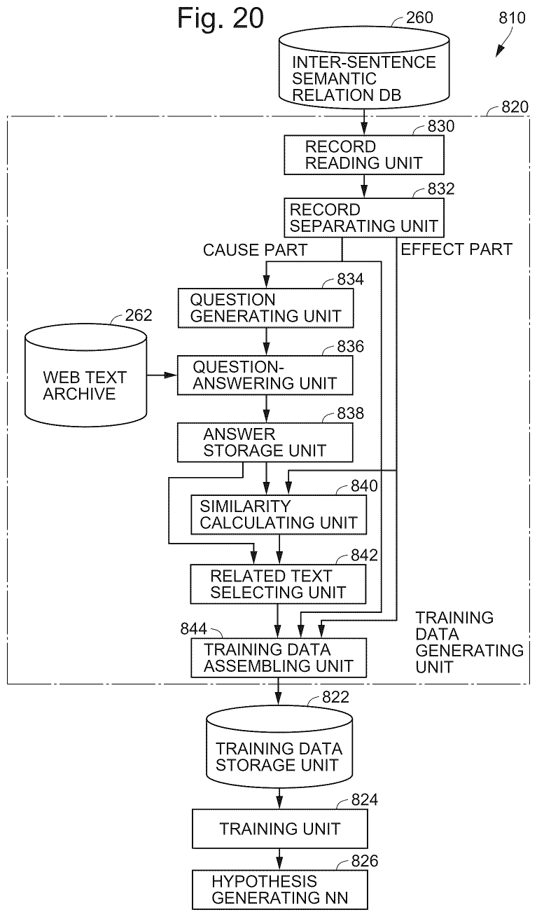

FIG. 20 shows a functional configuration of a training data generation system 810 for training a hypothesis generating neural network 826 in accordance with the eighth embodiment of the present invention. Here, hypothesis generating neural network 826 as the object of training is, though not specifically limited, of the same configuration as hypothesis generating neural network 122 of the embodiment shown in FIG. 1. The system that generates hypotheses using hypothesis generating neural network 826 may also be the same as hypothesis generation system 100 shown in FIG. 1.

The present embodiment is characterized by the method of generating training data for hypothesis generating neural network 826.

Training data generation system 810 includes: inter-sentence semantic relation DB 260; and a training data generating unit 820, for generating training data for hypothesis generating neural network 826 based on text pairs stored in inter-sentence semantic relation DB 260 and web text archive 262. The training data generated by training data generating unit 820 is stored in training data storage unit 822. Training unit 824 trains hypothesis generating neural network 826 using the training data stored in training data storage unit 822, and hypothesis generating neural network 826 generates hypotheses in response to the inputs.

In the present embodiment, the process of generating the training data is different from that of the first embodiment. It may be the case that as a result of this difference, hypothesis generating neural network 826 generates hypotheses different from that provided by hypothesis generating neural network 122 shown in FIG. 1.

Training data generating unit 820 includes: a record reading unit 830 for reading a text pair included in each record in inter-sentence semantic relation DB 260; and a record separating unit 832 for separating the text of record read by record reading unit 830 to the first sentence (in case of causality, cause part) and the second sentence (in case of causality, effect part).

Training data generating unit 820 further includes: a question generating unit 834 using the cause part output from record separating unit 832 to generate one or more question sentences; a question-answering unit 836 searching, in web text archive 262, for a plurality of answer passages including answers to each of the one or more questions generated by question generating unit 834, filtering to retain passages including appropriate answers and outputting the same; and an answer storage unit 838 for storing a plurality of answer passages output from question-answering unit 836.

Training data generating unit 820 further includes: a similarity calculating unit 840 calculating degree of similarity between each of the plurality of answer passages stored in answer storage unit 838 and the effect part (corresponding to the output of hypothesis generation) output from record separating unit 832; a related text selecting unit 842, based on the degree of similarity calculated for each of the plurality of answer passages by similarity calculating unit 840, for selecting an answer passage corresponding to the highest degree of similarity as the related text to the cause part (input); and a training data assembling unit 844 coupling the cause part output from record separating unit 832 as an input, the answer passage selected by related text selecting unit 842 as the related text and the effect part output by record separating unit 832 as an output, to assemble training data for the hypothesis generating neural network 826.

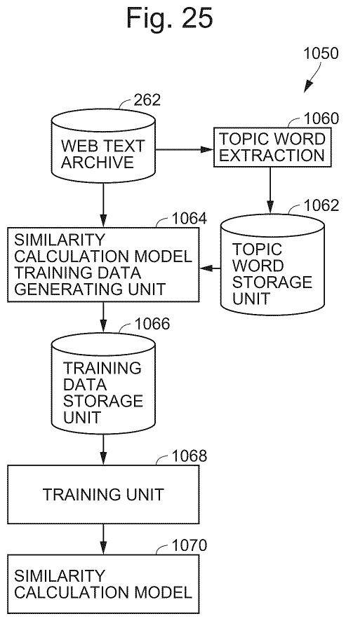

The method of calculating the degree of similarity by similarity calculating unit 840 will be described later with reference to FIGS. 25 to 28.

By the present embodiment, question generating unit 834 generates a question sentence from a cause part, question-answering unit 836 searches for a plurality of answer passages to the question sentence from web text archive 262, extracts from web text archive 262 and filters these to retain the passages including appropriate answers. Then, from the answer passages, one that has the highest similarity to the effect part is selected by similarity calculating unit 840 and related text selecting unit 842. As a result, by combining the cause part as an input, the related text that is the most relevant to the effect part of the causality corresponding to the cause part, and the effect part of the causality, training data for hypothesis generating neural network 826 is formed.

### 9. Ninth Embodiment

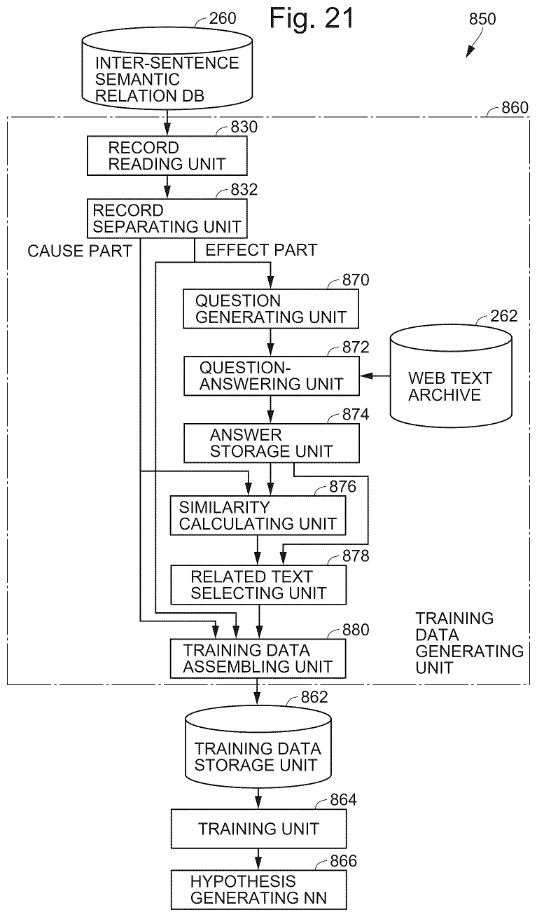

FIG. 21 shows a functional configuration of training data generation system 850 in accordance with the ninth embodiment of the present invention. The hypothesis generating neural network 866 to be trained in the ninth embodiment is not specifically limited, though it is assumed to have the same configuration as hypothesis generating neural network 122 of the embodiment shown in FIG. 1. The system for generating a hypothesis using hypothesis generating neural network 866 may also have the same configuration as hypothesis generation system 100 shown in FIG. 1.

The present embodiment is characterized in the method of generating training data for hypothesis generating neural network 866.

Training data generation system 850 includes: inter-sentence semantic relation DB 260 same as that of the eighth embodiment; and a training data generating unit 860 generating training data for hypothesis generating neural network 866, based on the text pairs stored in inter-sentence semantic relation DB 260 and on the web text archive 262. The training data generated by training data generating unit 860 is stored in training data storage unit 862. Training unit 864 trains hypothesis generating neural network 866 using the training data stored in training data storage unit 862, and hypothesis generating neural network 866 generates a hypothesis in response to an input.

In the present embodiment, the process of generating training data differs from the process of the first embodiment or the eighth embodiment. As a result of this difference, hypothesis generating neural network 866 generates hypotheses different from that provided by hypothesis generating neural network 122 shown in FIG. 1 or different from that provided by hypothesis generating neural network 826 shown in FIG. 20.

As in the example shown in FIG. 20, training data generating unit 860 includes: record reading unit 830 for reading text pairs included in each record of inter-sentence semantic relation DB 260; and record separating unit 832 for dividing the text of record read by record reading unit 830 into the first sentence (in case of causality, cause part) and the second sentence (in case of causality, effect part).

Training data generating unit 860 further includes: a question generating unit 870 for generating one or more question sentences using the effect parts output from record separating unit 832; a question-answering unit 872 extracting, from web text archive 262, a plurality of answer passages including answers to each of the one or more questions generated by question generating unit 870; and an answer storage unit 874 for storing a plurality of answer passages extracted by question-answering unit 872.

Training data generating unit 860 further includes: a similarity calculating unit 876 for calculating the degree of similarity between each of the plurality of answer passages stored in answer storage unit 874 and the cause part (corresponding to the input in hypothesis generation) output from record separating unit 832; a related text selecting unit 878 for selecting the answer passage corresponding to the highest similarity as the related text based on the similarity calculated for each of the plurality of answer passages by similarity calculating unit 876; and a training data assembling unit 880 for assembling training data for the hypothesis generating neural network 866 by concatenating the cause part output from record separating unit 832 as an input, the answer passage selected by related text selecting unit 878 as the related text, and the effect part output by record separating unit 832 as an output.

The method of calculating similarity by similarity calculating unit 840 is the same as that of the eighth embodiment and will be described later with reference to FIGS. 25 to 28.

By the present embodiment, question generating unit 870 generates a question sentence from the effect part, and question-answering unit 872 extracts a plurality of answer passages to the question sentence from web text archive 262. Then, from the answer passages, one that has the highest similarity to the cause part is selected by similarity calculating unit 876 and related text selecting unit 878. As a result, by combining the input corresponding to the cause part of causality, the related text that is the most relevant to the input text 110 among the answer passages obtained from the effect part of the causality, and the effect part of the causality, the training data for hypothesis generating neural network 826 is formed.

### 10. Tenth Embodiment

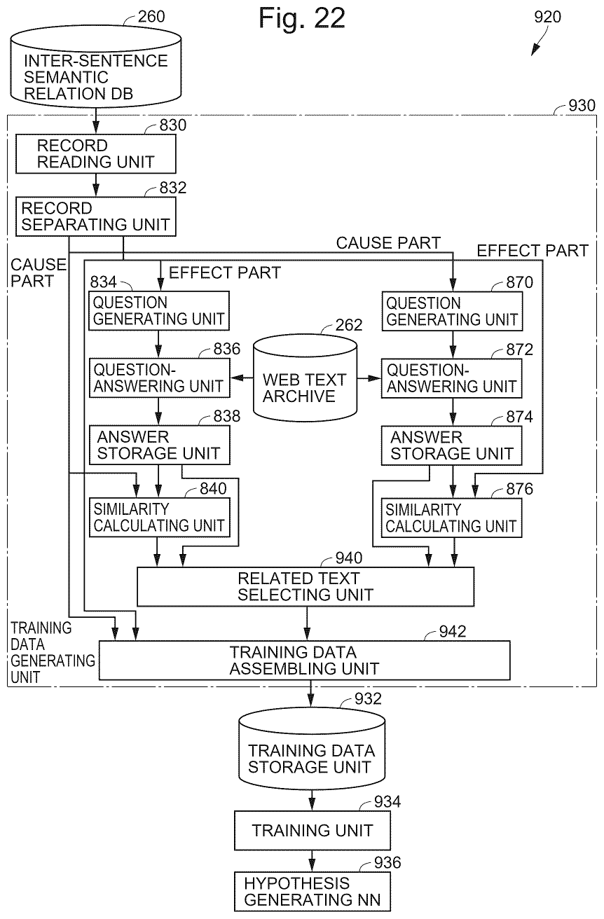

FIG. 22 shows a functional configuration of the tenth embodiment of the present invention. Referring to FIG. 22, the training data generation system 920 in accordance with the tenth embodiment includes a training data generating unit 930 for generating the training data for a hypothesis generating neural network 936. The training data generated by training data generating unit 930 is stored in a training data storage unit 932. A training unit 934 trains hypothesis generating neural network 936 using the training data stored in training data storage unit 932, and it becomes possible to use hypothesis generating neural network 936 in place of hypothesis generating neural network 122 shown in FIG. 1.

Training data generating unit 930 includes a part obtained by combining components of training data generating unit 820 shown in FIG. 20 and components of training data generating unit 860 shown in FIG. 21. More specifically, training data generating unit 930 includes record reading unit 830, record separating unit 832, question generating unit 834, question-answering unit 836, web text archive 262, answer storage unit 838 and similarity calculating unit 840, same as those shown in FIG. 20. Training data generating unit 930 further includes question generating unit 870, question-answering unit 872, answer storage unit 874 and similarity calculating unit 876, same as those shown in FIG. 21.

Training data generating unit 930 further includes: a related text selecting unit 940 for retrieving the answer passage having the highest similarity calculated by similarity calculating unit 840 from answer storage unit 838, and the answer passage having the highest similarity calculated by similarity calculating unit 876 from answer storage unit 874, respectively, and selecting the answer passage having higher similarity to output the same as related text; and a training data assembling unit 942 concatenating the cause part output from record separating unit 832 as an input, the answer passage output from related text selecting unit 940 as the related text, and the effect part output from record separating unit 832 as an output to form training data to be stored in training data storage unit 932.

Up to the calculation of degree of similarity by similarity calculating units 840 and 876, the process is the same as in the eighth and ninth embodiments. In training data generating unit 930, related text selecting unit 940 compares the degree of similarity calculated by similarity calculating unit 840 with the degree of similarity calculated by similarity calculating unit 876, and reads the answer passage corresponding to the higher degree of similarity from answer storage unit 838 or 874 and outputs the same to training data assembling unit 942. As a result, by combining the eighth and ninth embodiments, it becomes possible to generate the training data using the appropriate answer passage from either of these as the related text.

### 11. Eleventh Embodiment

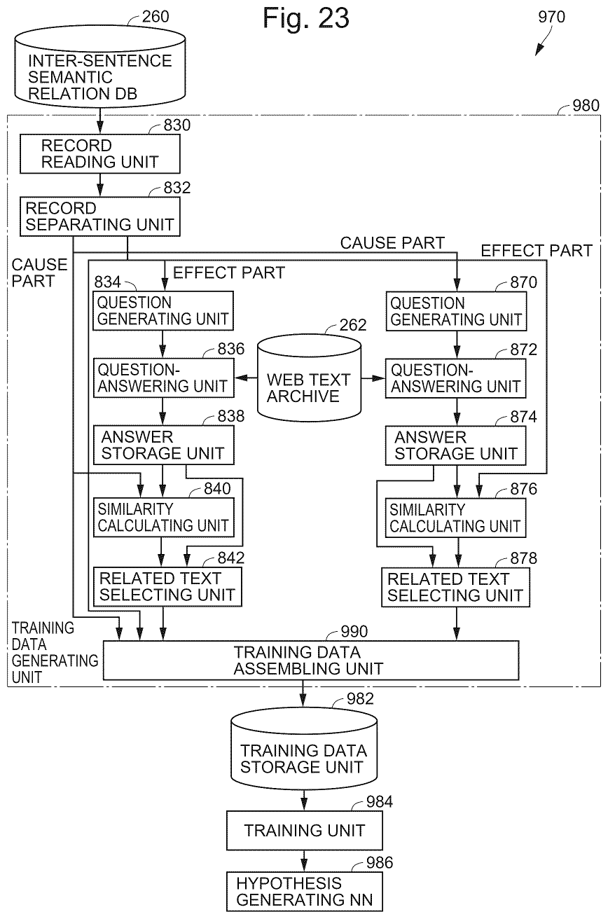

FIG. 23 shows a configuration of training data generation system 970 for generating the training data for a hypothesis generating neural network 986 in accordance with the eleventh embodiment of the present invention. In this example, the training data of hypothesis generating neural network 986 is the combination of an input, a related text, and an output, similar to those generated by the training data generation systems described above. The present embodiment, however, differs from other embodiments, particularly from the tenth embodiment, in the configuration of related text.

Referring to FIG. 23, training data generation system 970 in accordance with the eleventh embodiment includes a training data generating unit 980 for generating the training data for hypothesis generating neural network 986. The training data generated by training data generating unit 980 is stored in a training data storage unit 982. Training unit 984 trains hypothesis generating neural network 986 using the training data stored in training data storage unit 932. As a result, it becomes possible to use hypothesis generating neural network 986 in place of hypothesis generating neural network 122 shown in FIG. 1.

Referring to FIG. 23, the training data generation system 920 in accordance with the eleventh embodiment includes a training data generating unit 930 for generating the training data for a hypothesis generating neural network 936. The training data generated by training data generating unit 930 is stored in a training data storage unit 932. A training unit 934 trains hypothesis generating neural network 936 using the training data stored in training data storage unit 932, it becomes possible to use hypothesis generating neural network 936 in place of hypothesis generating neural network 122 shown in FIG. 1.

Training data generating unit 980 includes a part obtained by combining components of training data generating unit 820 shown in FIG. 20 and components of training data generating unit 860 shown in FIG. 21. More specifically, training data generating unit 930 includes record reading unit 830, record separating unit 832, question generating unit 834, question-answering unit 836, web text archive 262, answer storage unit 838, similarity calculating unit 840, and a related text selecting unit 842 same as those shown in FIG. 20. Training data generating unit 930 further includes question generating unit 870, question-answering unit 872, answer storage unit 874, similarity calculating unit 876, and a related text selecting unit 878, same as those shown in FIG. 21.

Training data generating unit 980 further includes a training data assembling unit 990 for concatenating a cause part output from record separating unit 832 as an input, a combination of an answer passage output from related text selecting unit 842 and an answer passage output from related text selecting unit 878 as the related text, and an effect part output from record separating unit 832 as an output, to form training data and storing the same in training data storage unit 982.

In the eleventh embodiment, the process up to the selection of answer passages by related text selecting units 842 and 878 is the same as that in the eighth and ninth embodiments. In the present training data generating unit 980, training data assembling unit 990 concatenates the answer passage selected by related text selecting unit 842 and the answer passage selected by related text selecting unit 878, and incorporates the result as the related data into the training data and, in this point, this embodiment differs from the tenth embodiment. Here, [September] is inserted between the answer passages.

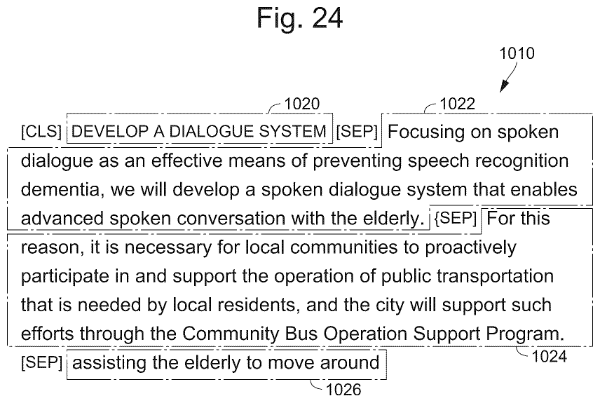

FIG. 24 shows the structure of an example of the training data output by training data assembling unit 990. Referring to FIG. 24, the training data 1010 has the form of “[CLS]+“develop a dialogue system” (input 1020)+[September]+the first related text 1022+[September]+the second related text 1024+[September]+“assist movement of the elderly” (output 1026)”. The first and second related texts 1022 and 1024 are the ones having the highest similarity to the cause part and to the effect part, respectively, among the answer passages obtained from the cause parts and the effect parts.

At the time of actual hypothesis generation, in the configuration shown in FIG. 1, two of the related texts stored in related text storage unit 116 may be selected and concatenated with [September] in between, and added to input text 110, to be input together to hypothesis generating neural network 986.

As a result, according to the eleventh embodiment, the eighth and ninth embodiments can be combined in a manner different from the tenth embodiment, and it becomes possible to generate the training data in which answer passages appropriate as the result of training are combined and used as the related text.

### 12. Similarity Calculation

In the eighth, ninth, tenth and eleventh embodiments of the present invention, degree of similarity between a cause part and an answer passage, and between an effect part and an answer passage, for example, are calculated. In the following, the method of calculating similarity will be described with reference to FIGS. 25 to 28.

Referring to FIG. 25, in the present embodiment, for calculating similarity, we use a similarity calculation model 1070 that is trained by deep learning. FIG. 25 shows a functional configuration of a training system 1050 for training the similarity calculation model 1070.

Referring to FIG. 25, training system 1050 includes: web text archive 262; a topic word extracting unit 1060 extracting a topic word from web text archive 262; and a topic word storage unit 1062 for storing the topic words extracted by topic word extracting unit 1060.

Here, though not limiting, the topic words refer to top N nouns that frequently appear in web text archive 262. It is noted, however, that predetermined stop words are not used as topic words.

Training system 150 further includes a similarity calculation model training data generating unit 1064 for generating training data for training similarity calculation model 1070 based on the web text stored in web text archive 262 and on the topic words stored in topic word storage unit 1062. The function of similarity calculation model 1070 in the present embodiment is to output, a feature vector, for each sentence or each passage, used for calculating similarity between a sentence or passage and another sentence or passage. The configurations of similarity model training data generating unit 1064 and of the feature vector required for that purpose will be described later.

Training system 1050 further includes: a training data storage unit 1066 for storing the training data generated by similarity model training data generating unit 1064; and a training unit 1068 for training similarity calculation model 1070 using the training data stored in training data storage unit 1066.

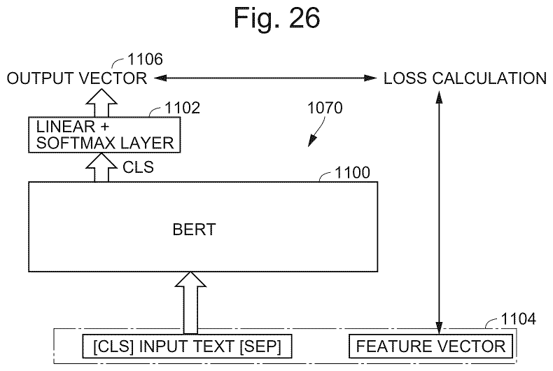

FIG. 26 schematically shows the manner of training of similarity calculation model 1070 used in the present embodiment. Referring to FIG. 26, for training similarity calculation model 1070, input text and feature vector calculated for the input text are used as training data.

Similarity calculation model 1070 includes: a language model 1100 knowns as BERT (Bidirectional Encoder Representations from Transformers); and a vector output unit 1102 consisting of a combination of a linear layer+Softmax layer, which receives, as an input, an output corresponding to the “CLS” at the beginning, of the outputs from language model 1100. BERT used as language model 1100 is pre-trained, and fine-tuned in a manner as will be described later.

Training data 1104 includes a combination of input text having [CLS] and [September] added to the beginning and end, respectively, and a feature vector calculated beforehand for the input text.

The feature vector of the teacher data 1104 is generated in the following manner. From web text archive 262 shown in FIG. 25, one sentence as the generation target of feature vector is extracted as an input sentence. Topic words that appear in three sentences, that is, the input sentence, the preceding one sentence and the succeeding one sentence, are specified. The number of these topic words is given as m. Even if one topic word appears twice or more in the three sentences, the topic word is counted once.

As the feature vector, a vector having the same number of elements as the number of topic words stored in topic word storage unit 1062 is used. As to the topic words appearing in the three sentences mentioned above, the value of the corresponding element is set to 1/m, and for the topic words not appearing in the three sentences, the value of the element is 0. The vector obtained in this manner is the feature vector of the input sentence (one sentence).

For each of the sentences in web text archive 262, it is possible to automatically calculate the feature vector in advance by the method described above.

Referring to FIG. 26, for training (fine tuning) the similarity calculation model 1070, input text of teacher data 1104 is input to language model 1100. As the output of vector output unit 1102 of similarity calculation model 1070, output vector 1106 is obtained. In the training, the parameters of similarity calculation model 1070 are trained such that sum of loss L calculated in accordance with the equation below is minimized between the feature vector of teacher data 1104 and the output vector 1106.

$$L = {\sum }_{i = 1}^{N} ( - {g}_{i} log {p}_{i} )$$

It is noted that in this equation, N represents the number of elements of the feature vector (the number of topic words), gᵢ represents the value of i-th element of teacher data's feature vector, and pᵢ represents the value of i-th element of the output vector.

By fine-tuning thus described, similarity calculation model 1070 predicts, when a sentence is input, topic words that would appear in the three sentences including that sentence, the preceding sentence, and the succeeding sentence.

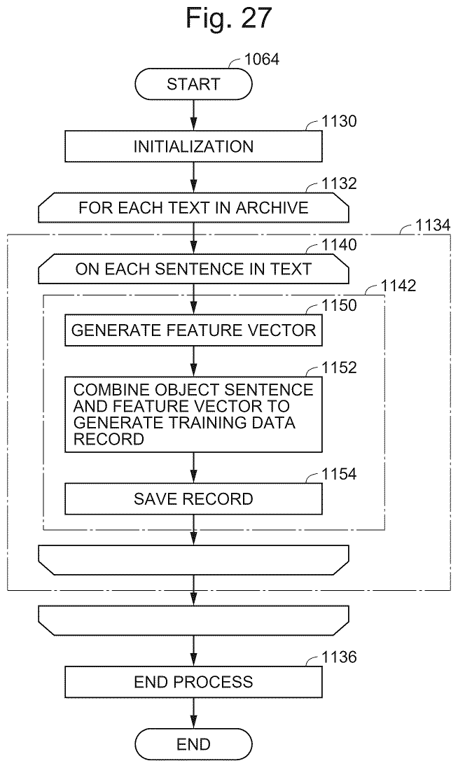

FIG. 27 shows, in the form of a flowchart, a control structure of a program realizing the similarity calculation model training data generating unit 1064 shown in FIG. 25. Referring to FIG. 27, this program includes: a step 1130 of initialization; a step 1132 of executing step 1134 for each text in web text archive 262 shown in FIG. 25; and a step 1136, responsive to the end of step 1132, of executing an end processing to end execution of the program.

Step 1134 includes a step 1140 of executing step 1142 on each sentence in the object text.

Step 1142 includes: a step 1150 of generating a feature vector in accordance with the method described above for the target sentence to be processed and the preceding and succeeding sentences, with reference to topic word storage unit 1062 shown in FIG. 25; a step 1152, following step 1150, of combining the object sentence and the feature vector calculated at step 1150 to generate a record of training data; and a step 1154 of saving the record of training data generated at step 1152 in training data storage unit 1066 shown in FIG. 25 and ending execution of step 1142.

By executing this program, training data for similarity calculation model 1070 can be generated.

The method of calculating the degree of similarity between a sentence or passage and an answer passage using the thus trained similarity calculation model 1070 will be described. In the following description, as shown in FIG. 20 as an example, similarity between a hypothesis passage (hypothesis output word sequence) stored in response storage unit 838 and an effect part of a text pair read from inter-sentence semantic relation DB 260 is calculated.

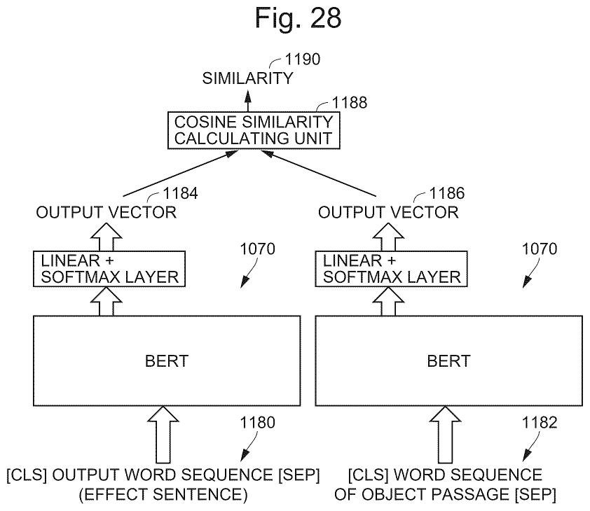

Referring to FIG. 28, a word sequence 1180 of the output (effect part) is input to similarity calculation model 1070, and as an output of similarity calculation model 1070, an output vector 1184 is obtained. On the other hand, a word sequence 1182 of the object passage is input to similarity calculation model 1070, and in an equivalent manner, an output vector 1186 is obtained. Output vectors 1184 and 1186 have the same dimension and, therefore, cosine similarity between them can be calculated. The calculated cosine similarity is regarded as the degree of similarity 1190 between the effect part and the object passage. As the cosine similarity calculating unit 1188 calculates similarity 1190 for each target passage, it becomes possible to specify the passage having the highest similarity.

In any of the eighth, ninth, tenth and eleventh embodiments, the degree of similarity can be calculated using similarity calculation model 1070.

### 13. Computer Implementation

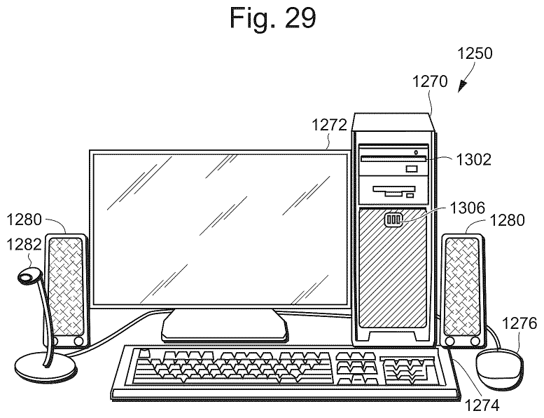

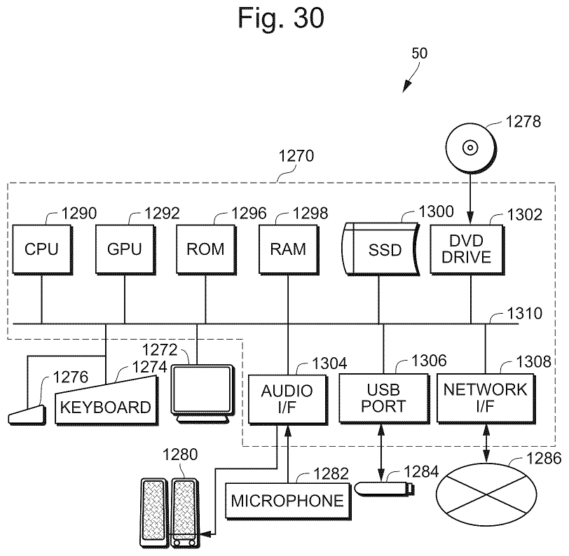

FIG. 29 shows an appearance of an example of a computer system realizing the embodiments described above. FIG. 30 is a block diagram showing an example of hardware configuration of the computer system shown in FIG. 29.

Referring to FIG. 29, computer system 1250 includes: a computer 1270 having a DVD (Digital Versatile Disc) drive 1302; and a keyboard 1274, a mouse 1276 and a monitor 1272, all connected to computer 1270 for interaction with the user. These are examples of equipment when user interaction becomes necessary, and any other general hardware and software (for example, a touch-panel, voice input, a pointing device and so on) allowing user interaction may be used.

Referring to FIG. 30, computer 1270 includes, in addition to DVD drive 1302, a CPU (Central Processing Unit) 1290, a GPU (Graphics Processing Unit) 1292, a bus 1310 connected to CPU 1290, GPU 1292, and DVD drive 1302, a ROM 1296 (Read Only Memory) connected to bus 1310 for storing boot up programs and the like of computer 1270, a RAM (Random Access Memory) 1298 connected to bus 1310, for storing instructions forming programs, a system program and work data, and an SSD (Solid State Drive) 1300, which is a non-volatile memory connected to bus 1310. SSD 1300 is for storing programs executed by CPU 1290 and GPU 1292, data used by the programs executed by CPU 1290 and GPU 1292 and so on. Computer 1270 further includes a network I/F (Interface) 1308 providing connection to a network 1286 allowing communication with other terminals; and a USB (Universal Serial Bus) port 1306 to which a USB memory 1284 may be detachably attached, providing communication with USB memory 1284 and different units in computer 1270.

Computer 1270 further includes: a speech I/F 1304 connected to microphone 1282, speaker 1280, a motion capture device, not shown, and to bus 1310, reading out a speech signal, a video signal and text data, generated by CPU 1290 and stored in RAM 1298 or SSD 1300 under the control of CPU 1290, to convert it into an analog signal, amplify it, and drive speaker 1280, digitizing an analog speech signal from microphone 1282 and storing it in addresses in RAM 1298 or in SSD 1300 specified by CPU 1290, or receiving a motion capture signal from the motion capture device and storing it in an address designated by CPU 1290.

In the above-described embodiments, the programs for realizing hypothesis generation systems 100, 510, 590, 730 and 770, training data generation systems 200, 250, 440, 620, 680, 810, 850, 920, 970 and 1050 and various functions of their components, parameters of neural networks and neural network programs are stored, for example, in SSD 1300, RAM 1298, DVD 1278 or USB memory 1284 shown in FIG. 30, or in an external storage device, not shown, connected through network I/F 1308 and network 1286. Typically, these data and parameters are written to SSD 1300 from outside, and at the time of execution by computer 1270, loaded to RAM 1298.

The computer program causing the computer system to realize functions of the above-described hypothesis generation systems 100, 510, 590, 730 and 770, the training data generation systems 200, 250, 440, 620, 680, 810, 850, 920, 970 and 1050, and their various components is stored in DVD 1278 that is loaded to DVD drive 1302, and transferred from DVD drive 1302 to SSD 1300. Alternatively, these programs may be stored in USB memory 1284, which USB memory 1284 is attached to USB port 1306, and the programs may be transferred to SSD 1300. Alternatively, the programs may be transmitted through network 1286 to computer 1270 and stored in SSD 1300.

At the time of execution, the programs will be loaded into RAM 1298.

Training and testing a neural network involve a huge amount of computation and, therefore, that program portion which is the main body of numerical calculation should preferably be realized not in script language but as an object program consisting of computer-native codes, to realize various units of the embodiments.

CPU 1290 fetches an instruction from RAM 1298 at an address indicated by a register therein (not shown) referred to as a program counter, interprets the instruction, reads data necessary to execute the instruction from RAM 1298, SSD 1300 or from other device in accordance with an address specified by the instruction, and executes a process designated by the instruction. CPU 1290 stores the resultant data at an address designated by the program, of RAM 1298, SSD 1300, register in CPU 1290 and so on. At this time, the value of program counter is also updated by the program. The computer programs may be directly loaded into RAM 1298 from DVD 1278, USB memory 1284 or through the network. Of the programs executed by CPU 1290, some tasks (mainly numerical calculation) may be dispatched to GPU 1292 by an instruction included in the programs or in accordance with a result of analysis during execution of the instructions by CPU 1290.

The programs realizing the functions of various units in accordance with the embodiments above by computer 1270 may include a plurality of instructions described and arranged to cause computer 1270 to operate to realize these functions. Some of the basic functions necessary to execute the instructions are provided by the operating system (OS) running on computer 1270, by third-party programs, or by modules of various tool kits installed in computer 1270. Therefore, the programs may not necessarily include all of the functions necessary to realize the system and method in accordance with the present embodiment. The programs have only to include instructions to realize the functions of the above-described various devices or their components by statically linking or dynamically calling appropriate functions or appropriate “program tool kits” in a manner controlled to attain desired results. The operation of computer 1270 for this purpose is well known and, therefore, description thereof will not be repeated here.

It is noted that GPU 1292 is capable of parallel processing and capable of executing a huge amount of calculation accompanying machine learning simultaneously in parallel or in a pipe-line manner. By way of example, parallel computational element found in the programs during compilation of the programs or parallel computational elements found during execution of the programs may be dispatched as needed from CPU 1290 to GPU 1292 and executed, and the result is returned to CPU 1290 directly or through a prescribed address of RAM 1298 and input to a prescribed variable in the program.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCE SIGNS LIST

100, 510, 590, 730, 770 hypothesis generation system
110 input text
112 keyword
114, 470, 490, 520, 570, 692 related text forming unit
116, 572 related text storage unit
122, 452, 524, 604, 782, 826, 866, 936, 986 hypothesis generating neural network
126, 526, 606, 784 hypothesis consecutive generation control unit
140, 220, 560, 834, 870 question generating unit
144, 210 large-scale corpus
146, 836, 872 question answering unit
148, 342, 474, 492, 540, 1022, 1024 related text
200, 250, 440, 620, 680, 810, 850, 920, 970 training data generation system
212 question sentence+preceding context extracting unit
214, 264, 450, 630, 696, 820, 860, 930, 980 training data generating unit
260 inter-sentence semantic relation DB
268, 824, 864, 934, 984, 1068 training unit
304 inter-sentence semantic relation knowledge
370 inter-sentence semantic relation type
1070 similarity calculation model
1100 language model
1188 cosine similarity calculating unit

1. A hypothesis generation device, comprising:
a related text forming unit, responsive to an input text, for generating a related text related to the text; and
a hypothesis generation model connected to receive the text and the related text as inputs, trained in advance so that the hypothesis generation model generates a hypothesis from an text to the model and a text related to the input text to the model.

2. The hypothesis generation device according to claim 1, wherein
the related text forming unit includes:
a question generating unit for generating one or more questions based on the text; and
a question-answering unit for searching an existing text archive for passages including an answer to the one or more questions generated by the question generating unit, and outputting the passages as the related texts.

3. The hypothesis generation device according to claim 1, further comprising: a hypothesis consecutive generating unit for having the hypothesis generation model generate a new hypothesis, by inputting the hypothesis generated by the hypothesis generation model in place of the input text to the related text forming unit.

4. The hypothesis generation device according to claim 1, further comprising:
a first selector for selecting and inputting to the related text forming unit either the input text or the hypothesis generated by the hypothesis generation model; and
a second selector for selecting, as an input to the hypothesis generation model, either the input text or the hypothesis generated by the hypothesis generation model, and inputting the selected one together with the related text to the hypothesis generation model, to have the hypothesis generation model generate a new hypothesis.

5. The hypothesis generation device according to claim 1, further comprising an input selector for selecting and inputting to the related text forming unit either the input text or the related text generated by the related text forming unit.

6. A hypothesis generation method, comprising the steps of:
a computer receiving an input of text and forming a related text related to the text; and
a hypothesis generation step of the computer providing the text and the related text to a hypothesis generation model trained in advance to generate a hypothesis from the text in response to the text and the related text and thereby generating a new hypothesis.
